(19) United States
(12) Patent Application Publication
(10) Pub. No.: US 2001/0019996 A1
(43) Pub. Date: Sep. 6, 2001

(54) PROCESS AND COMPOSITIONS PROMOTING BIOLOGICAL EFFECTIVENESS OF EXOGENOUS CHEMICAL SUBSTANCES IN PLANTS

(76) Inventors: GERARD G. SOULA, MEYZIEUX (FR); REMI MEYRUEIX, LYON (FR); ALAIN J.L. LEMERCIER, ST. BONNET DE MURE (FR); PHILIPPE G. CAISSE, SAINT BONNET DE MURE (FR); ANTHONY J.I. WARD, CLAYTON, MO (US); JANE L. GILLESPIE, ST. LOUIS, MO (US); RONALD J. BRINKER, ELLISVILLE, MO (US)

Correspondence Address: GAIL WUELLNER, MONSANTO COMPANY M2A, 800 NORTH LINDBERGH BOULEVARD, ST LOUIS, MO, 63167

(21) Appl. No.: 09/275,731

(22) Filed: Mar. 24, 1999

Related U.S. Application Data
(63) Continuation-in-part of application No. 09/105,639, filed on Jun. 26, 1998, now abandoned.
(60) Provisional application No. 60/082,974, filed on Apr. 24, 1998.
(60) Provisional application No. 60/083,005, filed on Apr. 24, 1998.
(60) Provisional application No. 60/113,954, filed on Dec. 23, 1998.

(51) Int. Cl. A01N 1/00; A01N 57/00; A01N 57/26; A01N 25/00; A01N 37/00; A01N 33/02; A01N 33/18; A01N 33/24

(52) U.S. Cl. 504/189; 504/194; 504/199; 424/405; 514/553; 514/661; 514/740

(57) ABSTRACT

A plant treatment composition for application of an anionic exogenous chemical substance such as glyphosate to foliage of a plant is provided. The composition comprises, in addition to the exogenous chemical substance, one or more amine compound(s) each having the formula (I)

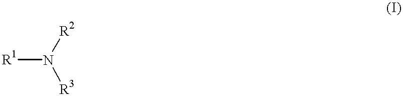

wherein R¹ is a hydrocarbyl group having 6 to about 22 carbon atoms, and R² and R³ are independently C₁₋₅ hydrocarbyl groups. The amine compound(s) of formula (I) are present in the composition in a mole ratio to the exogenous chemical substance of about 0.01:1 to about 2:1. The exogenous chemical substance and amine compound(s) of formula (I) are dissolved or dispersed in an agronomically acceptable liquid carrier, preferably water.

Also provided is a solid or liquid concentrate composition which, upon dissolution or dispersion in, or dilution with, water, forms a plant treatment composition of the invention. Plant treatment compositions of the invention are useful for eliciting a biological activity, for example herbicidal activity, in a plant.

This application is a continuation-in-part of application Ser. No. 09/105,639 filed Jun. 26, 1998, which claims the benefit of French Application No. 97-08371 filed Jun. 27, 1997, U.S. provisional application Ser. No. 60/082,974 filed Apr. 24, 1998 and U.S. provisional application Ser. No. 60/083,005 filed Apr. 24, 1998. This application also claims the benefit of U.S. provisional application Ser. No. 60/113,954 filed Dec. 23, 1998.

### FIELD OF THE INVENTION

The field of the present invention is that of exogenous chemical substances applied to foliage of plants, and relates particularly to a process and to compositions applied by that process for promoting biological effectiveness of such exogenous chemical substances.

The term “exogenous chemical substance” as used herein means a chemical substance, whether naturally or synthetically obtained, which is applied to a plant to result in expressing a desired biological activity. The term “biological activity” as used herein means elicitation of a stimulatory, inhibitory, regulatory, therapeutic, toxic or lethal response in the plant or in a pathogen, parasite or feeding organism present in or on the plant. Examples of exogenous chemical substances include, but are not limited to, chemical pesticides (such as herbicides, algicides, fungicides, bactericides, viricides, insecticides, miticides, nematicides and molluscicides), plant growth regulators, fertilizers and nutrients, gametocides, defoliants, desiccants, mixtures thereof and the like.

The term “biological effectiveness” is used herein to denote the degree to which a desired biological activity is expressed upon application of an exogenous chemical substance to foliage of a plant, or alternatively to denote the dosage or rate of application of the exogenous chemical substance that results in the desired biological activity being expressed to a given degree. For example, where the exogenous chemical substance is a herbicide, biological effectiveness can be measured by the degree of inhibition of plant growth resulting from application of a particular rate of the herbicide, or by the application rate of the herbicide required to cause a particular degree of inhibition, e.g., 50% or 85% inhibition. Thus increased or enhanced biological effectiveness of a herbicide can be exhibited for example as an increased level of plant growth inhibition at a given rate of the herbicide, or as a reduction in the minimum rate of the herbicide giving a certain threshold level of plant growth inhibition.

### BACKGROUND OF THE INVENTION

For many purposes in agriculture and related endeavors it is desired to treat plants with exogenous chemical substances of various kinds. Many exogenous chemical substances are applied to foliage (i.e., leaves and other non-woody above-ground parts) of a plant, and have a site of action in the plant either close to or remote from the locus of application. Such substances are referred to herein as foliar-applied exogenous chemical substances.

Typically, when an exogenous chemical substance is applied to foliage by plant treatment processes known in the art, only a small portion of the amount applied reaches sites of action in the plant where a desired biological activity of the exogenous chemical substance can be usefully expressed. It is therefore a major desideratum in agriculture and related endeavors to enhance the efficiency of delivery of foliar-applied exogenous chemical substances to their sites of action in plants, and thereby to enhance the biological effectiveness of the exogenous chemical substance for the purpose for which the exogenous chemical substance is used.

Application to foliage of an exogenous chemical substance by processes known in the art does not universally result in inefficient delivery to sites of action. In some situations such processes provide excellent biological effectiveness, even at a low use rate of the exogenous chemical substance. In other situations the same processes, using the same rate of the same exogenous chemical substance, provide inadequate biological effectiveness. Thus, these processes are inconsistent in the result they provide, or they cannot be relied upon to provide the desired result.

A problem is that it is seldom possible to identify in advance those situations where good biological effectiveness will be obtained, partly because so many factors influence efficiency of delivery. These factors include weather (temperature, relative humidity, daylength, cloudiness, precipitation, wind, etc.) preceding, during and following application, soil conditions (fertility, aeration, etc.), plant growth stage, health and physiological status, equipment-related inaccuracies in application, and other factors. Therefore, to help ensure reliable or consistent biological effectiveness of a foliar-applied exogenous chemical substance, the user typically applies the substance at a higher rate than is truly necessary in the majority of situations.

Variability in biological effectiveness in field conditions is an especially troublesome problem in the case of exogenous chemical substances that are acids, and are typically formulated as water-soluble salts in which the exogenous chemical substance is present in an anionic form. Sometimes by converting such acid substances to esters, this variability can be moderated; however, in many cases esters show reduced biological effectiveness, for example due to inadequate conversion back to the parent acid once inside the treated plant. There remains a strong need for enhanced biological effectiveness, and enhanced reliability of biological effectiveness, of foliar-applied exogenous chemical substances, particularly anionic exogenous chemical substances.

The term “anionic exogenous chemical substance” as used herein means an exogenous chemical substance whose molecular structure includes one or more acid, or proton-donating, sites, and is therefore capable of forming an anion in the presence of a proton acceptor. The term therefore embraces substances that are zwitterionic. In describing an exogenous chemical substance as “anionic” herein, it is not implied that the exogenous chemical substance is necessarily in anionic form or that it is dissociated.

Benefits of a process providing greater reliability of biological effectiveness include an ability to reduce rates of application of exogenous chemical substances without sacrificing consistency of biological effectiveness. Pressures felt by the agricultural industry to reduce pesticide, particularly herbicide, usage are well evidenced by symposia on the subject, such as that held in 1993 by the Weed Science Society of America and documented in Weed Technology 8, 331-386 (1994). Reduced use rates bring rewards not only environmentally but also economically, as the cost per unit area treated decreases.

Foliar-applied exogenous chemical substances have frequently been applied together with amphiphilic materials, particularly amphiphilic surface-active agents, otherwise known as surfactants. Surfactants can influence biological effectiveness of a foliar-applied exogenous chemical substance in numerous ways.

When a dilute aqueous composition of an exogenous chemical substance is applied to foliage by conventional hydraulic spraying, the presence of surfactant in the dilute aqueous composition can alter the size distribution of the spray droplets, typically increasing the percentage of spray volume in the form of small droplets and reducing the percentage of spray volume in the form of large droplets. As smaller droplets have lower momentum than larger droplets, these smaller droplets are less likely to rebound from a foliar surface and consequently are more likely to be retained on that surface. Spray retention can also be facilitated by adhesion of surfactant molecules in a spray droplet to the foliar surface, which in most plants is waxy and hydrophobic. This adhesion reduces not only rebound but also run-off of spray droplets from the foliar surface. Surfactants also tend to increase the area of contact between a spray droplet and a foliar surface, and in many cases enhance penetration of an exogenous chemical substance from the droplet into and through cuticles of leaves to reach internal leaf tissues.

Through these and perhaps other effects, amphiphilic materials including surfactants have long been known to increase the biological effectiveness of exogenous chemical substances. It is therefore commonplace for one or more surfactants to be included in commercial formulations of foliar-applied exogenous chemical substances, even in formulations that do not require the presence of surfactants for acceptable physical stability or handling properties, for example as emulsifying or suspending agents or dispersants.

One of the most extensively studied of foliar-applied anionic exogenous chemical substances, from the point of view of the role of surfactants in enhancing biological effectiveness, is the herbicide glyphosate. As well as being a phytotoxic agent, glyphosate has been used as a plant growth regulator.

Glyphosate (N-phosphonomethylglycine) in its strict sense is an acid compound, but the word “glyphosate” is herein used in a less restrictive sense, except where the context dictates otherwise, to encompass not only glyphosate acid but also salts, adducts and esters thereof, and compounds which are converted to glyphosate in plant tissues or which otherwise provide glyphosate ions. In most commercial formulations of glyphosate, the glyphosate is present as a water-soluble salt. In this respect, glyphosate is typical of most exogenous chemical substances that are acids or that form anions.

Herbicidal salts of glyphosate are disclosed, for example, in U.S. Pat. No. 3,799,758 to Franz, U.S. Pat. No. 3,853,530 to Franz, U.S. Pat. No. 4,140,513 to Prill, U.S. Pat. No. 4,315,765 to Large, U.S. Pat. No. 4,405,531 to Franz, U.S. Pat. No. 4,481,026 to Prisbylla and U.S. Pat. No. 4,507,250 to Bakel. In most of the salts disclosed, the counterion to glyphosate anion is a relatively low molecular weight, non-amphiphilic cation. Typical of such salts are alkali metal, for example sodium and potassium, salts; ammonium salt; and numerous salts having an ammonium, sulfonium or sulfoxonium cation substituted with 1-3 organic groups containing in total 1-6 carbon atoms, for example dimethylammonium, isopropylammonium, ethanolammonium and trimethylsulfonium salts.

Commercial formulations of glyphosate salts include, for example, Roundup®, Accord®, Roundup® Ultra and Roundup® Xtra herbicides of Monsanto Company, which contain the isopropylammonium salt, Roundup® Dry and Rival® herbicides of Monsanto Company, which contain the ammonium salt, Roundup® Geoforce herbicide of Monsanto Company, which contains the sodium salt, and Touchdown® herbicide of Zeneca, which contains the trimethylsulfonium salt.

Salts of glyphosate with higher molecular weight, amphiphilic cations have also been disclosed. Such amphiphilic cations include those having a hydrophilic moiety such as an ammonium, ethanolammonium, polyoxyethylene ammonium, or sulfonium group, and a hydrophobic moiety comprising 1 to 4 hydrocarbyl groups having in total more than 6 carbon atoms. For example, above-cited U.S. Pat. No. 4,405,531, the disclosure of which is incorporated herein by reference, discloses a wide range of primary, secondary and tertiary ammonium salts of glyphosate wherein the cation is amphiphilic as defined immediately above and has a molecular weight of less than about 300. Examples include C₆₋₁₈ alkylammonium cations. International Publication No. WO 83/03608, European Patent Application No. 0 124 351 and U.S. Pat. No. 4,431,594 disclose various quaternary ammonium salts of glyphosate wherein the cation is amphiphilic. U.S. Pat. No. 5,668,085 discloses salts of glyphosate with amphiphilic cations derived from polyoxyethylene tertiary C₈₋₂₂ alkylamine surfactants, a specifically disclosed example being the N-cocoalkyl-N,N-diethanolammonium salt of glyphosate where “cocoalkyl” refers to a mixture of predominantly C₁₂ and C₁₄ alkyl chains, derived from coconut oil. Above-cited European Patent Application No. 0 124 351 discloses a salt of glyphosate wherein the cation is derived from a tertiary alkylamine, namely the dimethyldodecylammonium salt, and indicates that preferably the mole ratio of such alkylamine to glyphosate is 1:1.

Glyphosate as a herbicide has many advantages, particularly environmental advantages including biodegradability and low ecotoxicity. However, studies have shown that even the most biologically effective formulations of glyphosate presently in use do not deliver glyphosate efficiently to sites in the plant where the glyphosate exerts its phytotoxic effect. Typically, only a small fraction of the applied herbicide arrives at such sites.

The small fraction of applied glyphosate which reaches sites of phytotoxic action is related to the fact that the glyphosate must go through several barriers. Among these, one of the most important is believed to be the lipophilic cuticle on the foliar surface to which the glyphosate is applied. It has therefore been theorized that it would be desirable to place the glyphosate into an amphiphilic medium which would provide greater compatibility between the lipophilic cuticle and the hydrophilic glyphosate, and thereby facilitate penetration of glyphosate into and through the cuticle. Similar thinking has been applied to other exogenous chemical substances, particularly those typically formulated as water-soluble salts.

That the concept of an amphiphilic medium as an aid to cuticular penetration and thereby enhanced biological effectiveness, for example of glyphosate, has validity is demonstrated by many studies in which foliar uptake or effectiveness has been enhanced by surfactants. An extensive study by Wyrill & Burnside, Weed Science 25, 275-287, 1977 led to a conclusion that “an effective surfactant is a critical component of any glyphosate spray mixture”, but noted great variation among surfactant types in the degree of enhancement of herbicidal effectiveness afforded. In general, cationic surfactants gave greater enhancement than nonionic surfactants. Among the surfactants disclosed by Wyrill & Burnside are the alkylamine surfactants Armeen™DM12D and Armeen™DM16D, identified respectively as dodecyldimethylamine and hexadecyldimethylamine. Tested only at molar concentrations vastly in excess of glyphosate molar concentration (10.5:1 and 21:1 alkylamine/glyphosate mole ratios for Armeen™DM12D; 8.3:1 and 16.6:1 alkylamine/glyphosate mole ratios for Armeen™DM16D), these surfactants were found by Wyrill & Burnside to be relatively ineffective in enhancing herbicidal activity; however, the surfactant TD-692, identified as dodecyldimethylammonium succinate, (at 6.8:1 and 13.5:1 alkylamine/glyphosate mole ratios) was more effective. It is well accepted by those of skill in the art that relative effectiveness of surfactants in enhancing biological activity of an exogenous chemical substance, particularly glyphosate, at high surfactant levels does not permit reliable prediction of relative effectiveness at much lower surfactant levels, as in the realm of the present invention.

Data are reported in International Publication No. WO 98/06259 for a wide range of cationic, nonionic, anionic and amphoteric surfactants applied either in mixture with, or in sequence following, a glyphosate composition.

Another approach to providing an amphiphilic medium has been to apply glyphosate together with a lipophilic agent, such as an oil, in the form of a water-in-oil emulsion or microemulsion. Such emulsions or microemulsions are disclosed in European Patent Application No. 0 379 852, U.S. Pat. No. 4,853,026 and U.S. Pat. No. 5,248,086. A disadvantage of such microemulsions is that, when provided as concentrate compositions, they are subject to the phenomenon of breaking of the emulsion upon dilution with water to concentrations suitable for application, for example, 5 grams of glyphosate, expressed as acid equivalent, per liter (g a.e./l). In other words, water-in-oil microemulsions tend not to withstand dilution in water. The failure of such microemulsions to provide improved cuticular penetration is perhaps related to this inability to withstand dilution.

Oil-in-water macroemulsion formulations of glyphosate have also been investigated. In these macroemulsions, the majority of the glyphosate is present in the continuous aqueous phase, as shown, for example, in European Patent Application No. 0 485 207. Such macroemulsions, in which the glyphosate and the lipophilic component are segregated, do not therefore provide glyphosate in an amphiphilic form, and have generally not enhanced delivery of glyphosate to its sites of phytotoxic action in the plant.

A different approach, illustrated in European Patent Specification No. 0 148 169, is to encapsulate a water-soluble herbicide such as glyphosate in a polymeric shell by interfacial polycondensation. In this technique, a water-in-oil emulsion having a lipophilic emulsifier based on alkylated polyvinylpyrrolidone is used. Polymerization to form the shell, by reaction of comonomers, occurs at the oil-water interface of the emulsion containing the herbicide, resulting in formation of a shell that encapsulates the herbicide.

Compositions wherein glyphosate is accompanied by an N-(C₆₋₂₂)alkyl-N,N-di(C₁₋₅)alkylamine compound or salt thereof are believed to have been disclosed only where the mole ratio of such amine compound to glyphosate is at least 1:1 (as in the above-cited European Patent Application No. 0 124 351) or, on the other hand, is extremely low. For example, International Publication No. WO 97/16969 discloses glyphosate compositions wherein N-decyl-N,N-dimethylammonium chloride is added in a small amount to enhance stability of the composition in the presence of a much larger amount of another surfactant. The highest mole ratio of N-decyl-N,N-dimethylamine to glyphosate specifically disclosed is about 0.02:1.

All of the approaches summarized above, including formulating an anionic exogenous chemical substance as an amphiphilic salt, have met with limited success in overcoming the barriers to delivery of the exogenous chemical substance to its sites of biological action in the plant. It is an objective, therefore, of the present invention to provide a new composition or formulation of an exogenous chemical substance, in particular an anionic exogenous chemical substance, that can provide superior biological effectiveness when applied to foliage of a plant.

Another objective of the invention is to provide a composition or formulation of an exogenous chemical substance, in particular an anionic exogenous chemical substance, that is economical and simple to make.

Another objective of the invention, particularly as it applies to the herbicide glyphosate, is to provide a composition or formulation that meets the previously stated objectives while permitting maintenance of the non-ecotoxic and biodegradable character of glyphosate.

Another objective of the invention is to provide a composition or formulation of an exogenous chemical substance, particularly an anionic exogenous chemical substance, that can be applied in a dilute aqueous medium and does not lose its beneficial properties at high rates of dilution.

Another objective of the invention is to provide an aqueous composition or formulation of an anionic exogenous chemical substance in the form of an amphiphilic salt that is physically stable, even at high concentration, without the need for additional stabilizing agents such as dispersants or emulsifying agents.

Another objective of the invention is to provide a concentrate composition comprising an amphiphilic salt of an exogenous chemical substance, having a higher concentration, or loading, of the exogenous chemical substance than has previously been possible using such a salt. Increased loading results in reduced packaging, storage and transportation cost and in reduced environmental impact of container disposal, as well as providing a more convenient product for use by farmers and others.

Another objective of the invention is to provide a convenient and economical method for the preparation of a composition or formulation that meets the objectives stated above.

Another object of the invention is to provide a useful alternative to existing formulations of anionic exogenous chemical substances.

These and other objectives have been satisfied through design of a new approach for promoting transport of an anionic exogenous chemical substance into plants via foliage, and thereby promoting biological effectiveness and economic utilization of the exogenous chemical substance. This approach is set out more fully below.

### DESCRIPTION OF THE FIGURES

FIG. 1 is a transmission electron micrograph of an aqueous formulation of an amphiphilic salt of N-phosphonomethylglycine prepared according to Example 1 hereof. The scale bar represents 100 nm. This micrograph shows supramolecular aggregates, appearing as substantially spherical beads ranging in diameter from about 20 to about 100 nm. It will be recognized that the limit of resolution of transmission electron microscopy as used herein is approximately 20 nm, thus although smaller supramolecular aggregates are believed to be present they are not visible in this micrograph or the micrograph of FIG. 2.

FIG. 2 is a transmission electron micrograph of an aqueous formulation of an amphiphilic salt of N-phosphonomethylglycine prepared according to Example 6 hereof. The scale bar represents 100 nm. This micrograph shows supramolecular aggregates, appearing as substantially spherical beads ranging in diameter from about 20 to about 100 nm.

FIG. 3 is a graphical representation of the size distribution of emulsion particles in a composition prepared according to Example 7 hereof.

### SUMMARY OF THE INVENTION

A plant treatment composition for application to foliage of a plant to elicit a biological response is now provided, comprising an anionic exogenous chemical substance and one or more amine compound(s) each having the formula (I)

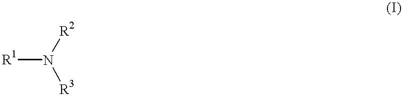

wherein R¹ is a hydrocarbyl group, preferably a linear hydrocarbyl chain, having 6 to about 22 carbon atoms, and R² and R³ are independently C₁₋₅ hydrocarbyl groups. The exogenous chemical substance is present in the composition in an amount sufficient to elicit the biological response when the composition is applied to the foliage of the plant at a rate of about 10 to about 1000 liters per hectare (l/ha). The amine compound(s) of formula (I) are present in the composition typically in a mole ratio to the exogenous chemical substance of about 0.01:1 to about 2:1. The exogenous chemical substance and amine compound(s) of formula (I) are dissolved or dispersed in an agronomically acceptable liquid carrier, preferably water. The composition is further characterized in that

(i) the mole ratio of amine compound(s) of formula (I) to the exogenous chemical substance is about 0.05:1 to about 0.8:1, preferably about 0.1 to about 0.5:1; and/or

(ii) the hydrocarbyl group represented by R¹ in the amine compound(s) of formula (I) has 14 to about 22 carbon atoms; and/or

(iii) an adjuvant compound having a molecular structure that comprises a polyoxyethylene chain having about 2 to about 100 ethylene oxide units is present in the composition in a weight ratio to the exogenous chemical substance of about 1:10 to about 10:1, preferably about 1:3 to about 3:1.

In a first embodiment of the invention, the composition comprises an aqueous application medium, in which supramolecular aggregates are colloidally dispersed. The supramolecular aggregates comprise one or more amphiphilic salt(s) having anions of the anionic exogenous chemical substance and cations derived by protonation of the amine compound(s) of formula (I). In this first embodiment, the exogenous chemical substance is present in the composition in one to three molar amounts:

(a) a first molar amount X¹ neutralized by said amine compound(s);

(b) a zero or second molar amount x neutralized by one or more base(s) other than the amine compound(s) that neutralize the first molar amount X¹; and

(c) a zero or third molar amount X³ in the form of an acid, unneutralized by any base.

Reference herein to molar amounts present of an anionic exogenous chemical substance in salt form or neutralized by a base (i.e., X¹ and X²) is based upon a presumption that unreacted acid and base do not coexist in the composition but does not imply that such presumption is necessarily correct or valid. Indeed it is believed that the acid-base neutralization process providing amphiphilic salt(s) as defined above is complex and can result in the coexistence of unreacted acid and base. Thus the molar amount X¹ or X² as used herein is determined by the molar amount of the appropriate base present, regardless of (i) the proportion of that base which is protonated or in the form of cations, (ii) the proportion of the exogenous chemical substance which is deprotonated, i.e., in the form of anions, or (iii) the degree to which the base and the exogenous chemical substance are associated or dissociated in the composition. The molar amount X³ refers to unneutralized acid in excess of that encompassed in X¹ and X².

X^{1,} X² and X³ are measured by the molar amounts of exogenous chemical substance present and amine compound(s) of formula (I) and other base(s) added, as follows.

1. Where the exogenous chemical substance has only one acid group available for deprotonation and the total molar amount of base(s) added is not greater than the total molar amount of the exogenous chemical substance present, X¹ is defined herein as equal to the molar amount of the amine compound(s) of formula (I), and X² is defined herein as equal to the molar amount of the other base(s). X³ is derived by subtraction of (X¹+X²) from the total molar amount of exogenous chemical substance present.

2. Where the exogenous chemical substance has more than one acid group available for deprotonation and the total molar amount of base(s) added is not greater than the total molar amount of the exogenous chemical substance present, X¹, X² and X³ are defined as in 1 above.

3. Where the exogenous chemical substance has more than one acid group available for deprotonation and the total molar amount of base(s) added is 1-2 times the total molar amount of the exogenous chemical substance present, X³ is defined to be zero. X¹ as a fraction of (X¹+X²) is defined to be equal to the molar amount of amine compound(s) of formula (I) as a fraction of the total molar amount of base(s) added. In other words, if the molar amount of amine compound(s) of formula (I) added is α, and if the molar amount of other base(s) added is b, then

X¹/(X¹+X²)=a/(a+b),

and

X²/(X¹+X²)=b/(a+b).

In this first embodiment, the second molar amount, if present, of the exogenous chemical substance is preferably neutralized by one or more base(s) providing monovalent cations selected from alkali metal cations, ammonium cations, organic ammonium or sulfonium cations having in total 1-6 carbon atoms, and trialkylammonium cations wherein alkyl groups each have 4-6 carbon atoms. An exception to this is a composition where the first molar amount is neutralized by amine compound(s) wherein the hydrocarbyl group R¹ has 14 to about 22 carbon atoms; in such a composition the base(s) for neutralizing the second molar amount are selected from those listed immediately above and amine compounds of formula (I) wherein the hydrocarbyl group R¹ has no more than 12 carbon atoms.

In a second embodiment of the invention, the composition comprises an aqueous application medium, in which are dissolved or dispersed the anionic exogenous chemical substance and the amine compound(s) of formula (I), wherein supramolecular aggregates as defined herein are optionally present but wherein substantially no amphiphilic salt of the exogenous chemical substance is present in such supramolecular aggregates. Preferably in this second embodiment the exogenous chemical substance is in the form of a water-soluble salt wherein the cationic counterion is of low molecular weight, and each of the amine compound(s) of formula (I) is in the form of a salt formed with an acid that is not an exogenous chemical substance as defined herein. More preferably the cationic counterion of the exogenous chemical substance salt is a monovalent cation selected from alkali metal cations, ammonium cations, and organic ammonium and sulfonium cations having in total 1-6 carbon atoms. By “low molecular weight” in the context of a cationic counterion is meant having a molecular weight lower than about 100.

The requirement in this second embodiment that “substantially no amphiphilic salt of the exogenous chemical substance is present” in supramolecular aggregates is satisfied where, in a composition of the invention, (1) substantially no supramolecular aggregates exist or can be identified by techniques disclosed herein; or (2) supramolecular aggregates are identifiably present but are determined by techniques known in the art to contain substantially none of the exogenous chemical substance; or (3) supramolecular aggregates are identifiably present but substantially all of the exogenous chemical substance is determined by techniques known in the art to be present in the aqueous medium.

The second embodiment of the invention can therefore be defined as a plant treatment composition for application to foliage of a plant to elicit a biological response, comprising an agronomically acceptable liquid carrier, preferably water, wherein are dissolved or dispersed an anionic exogenous chemical substance and one or more amine compound(s) each having the formula (I)

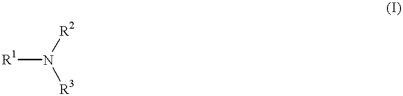

wherein R¹ is a hydrocarbyl group, preferably a linear hydrocarbyl chain, having 6 to about 22 carbon atoms, and R² and R³ are independently C₁₋₅ hydrocarbyl groups; wherein the exogenous chemical substance is present in the composition in an amount sufficient to elicit the biological response when the composition is applied to the foliage of the plant at a rate of about 10 to about 1000 liters per hectare (l/ha); wherein the amine compound(s) of formula (I) are present in the composition typically in a mole ratio to the exogenous chemical substance of about 0.01:1 to about 2:1; wherein the composition is further characterized in that

(i) the mole ratio of amine compound(s) of formula (I) to the exogenous chemical substance is about 0.05:1 to about 0.8: 1, preferably about 0.1:1 to about 0.5:1; and/or

(ii) the hydrocarbyl group represented by R¹ in the amine compound(s) of formula (I) has 14 to about 22 carbon atoms; and/or

(iii) an adjuvant compound having a molecular structure that comprises a polyoxyethylene chain having about 2 to about 100 ethylene oxide units is present in the composition in a weight ratio to the exogenous chemical substance of about 1:10 to about 10:1, preferably about 1:3 to about 3:1; and wherein the composition is other than a composition of the first embodiment as defined above.

A preferred anionic exogenous chemical substance useful in any of the above embodiments of the invention is N-phosphonomethylglycine.

A concentrate composition is also provided, which when dissolved or dispersed in, or diluted with, a suitable amount of water forms a plant treatment composition as described above. Such concentrate composition can be solid or liquid. A contemplated solid concentrate composition contains in total at least about 5% by weight and up to about 75% or more by weight of the exogenous chemical substance expressed as acid equivalent (a.e.). A contemplated liquid concentrate composition contains in total at least about 5% by weight and up to about 50% or more by weight of the exogenous chemical substance expressed as acid equivalent (a.e.).

Also provided is a process for making a liquid concentrate composition of the first embodiment of the invention, comprising a neutralizing step and a conditioning step.

The neutralizing step comprises neutralization of a first molar amount X¹ of an anionic exogenous chemical substance with one or more amine compound(s) of formula (I) in a liquid, preferably aqueous, medium with agitation to make a liquid composition containing one or more amphiphilic salt(s) of the exogenous chemical substance. Optionally the neutralizing step further comprises introducing to the liquid composition, with agitation, a second molar amount X² of the exogenous chemical substance in the form of one or more salt(s) other than the amphiphilic salt(s) formed by neutralizing the first molar amount X¹. Optionally and independently of the presence of the second molar amount, a third molar amount X³ of the exogenous chemical substance is present in an acid form and is not neutralized. The salt(s) of the second molar amount of the exogenous chemical substance can be made in situ by neutralizing, in the liquid medium with agitation, this second molar amount with one or more base(s) before, during or after neutralization of the first molar amount; alternatively such salt(s) can be prepared separately by processes known in the art and added to the liquid medium before, during or after neutralization of the first molar amount.

The conditioning step comprises continuing the agitation of the liquid composition until supramolecular aggregates comprising amphiphilic salt(s) of the exogenous chemical substance formed by neutralizing the exogenous chemical substance with amine compound(s) of formula (I) are colloidally dispersed in the liquid medium.

Other ingredients of the composition, such as for example an adjuvant compound having a molecular structure that comprises a polyoxyethylene chain having about 2 to about 100 ethylene oxide units, are added if necessary during, before or after any of the process steps described immediately above.

Where an anionic exogenous chemical substance has a molecular structure with only one acid site, the term “neutralizing” is to be understood to mean admixing a first or second molar amount of acid with a substantially equimolar amount of base. Where an anionic exogenous chemical substance has a molecular structure with two or more acid sites, as is the case for example with N-phosphonomethylglycine, the term “neutralizing” is to be understood to mean admixing a first or second molar amount of acid with about 1 to about 2 moles of base per mole of acid to form a monobasic salt, a dibasic salt, or a mixture thereof.

It is further to be understood that the term “neutralizing” as used herein refers simply to the admixture of acid and base, and does not necessarily imply reaction of all of the acid and base to form a salt.

An alternative process for making a liquid concentrate composition of the invention comprises a step of preparing a first concentrated aqueous solution or dispersion comprising a salt of an anionic exogenous chemical substance with a low molecular weight cationic counterion, a step of preparing a second concentrated aqueous solution or dispersion comprising an acid salt of an amine compound of formula (I), and a step of mixing the first and second concentrated solution or dispersion to form the liquid concentrate composition. Optionally the composition thus produced is adjusted by addition of water to obtain a desired final concentration of ingredients. Other ingredients of the composition, such as for example an adjuvant compound having a molecular structure that comprises a polyoxyethylene chain having about 2 to about 100 ethylene oxide units, are added if necessary during, before or after any of the process steps described immediately above.

The product of this alternative process can be tested by techniques disclosed herein for the presence of supramolecular aggregates colloidally dispersed in an aqueous medium, and by techniques known in the art for the presence of the exogenous chemical substance in such supramolecular aggregates and/or in the aqueous medium. The results of such tests will determine whether the product is a composition of the first or of the second embodiment as defined above.

A “concentrated” aqueous solution or dispersion is defined herein as one having a concentration of at least about 5% by weight of the exogenous chemical substance, expressed as acid equivalent, or of the amine compound of formula (I), but not exceeding a maximum concentration above which the resulting composition would be unstable, nonhomogeneous or nonfluid (as, for example, a gel or paste). Typically a concentrated aqueous solution of a salt contains about 10% by weight to a maximum percentage by weight corresponding to the limit of solubility of the salt at 20° C.

The first concentrated aqueous solution or dispersion used in the alternative process described above can be a product of commerce, such as for example MON 0139 of Monsanto Company, which is a 62% by weight aqueous solution of glyphosate isopropylammonium salt. Alternatively, the first concentrated aqueous solution or dispersion can be prepared by dissolving or dispersing a solid salt of the exogenous chemical substance in water, or by reacting the exogenous chemical substance in its acid form with a suitable low molecular weight base in an aqueous medium.

The second concentrated aqueous solution or dispersion used in the alternative process described above can be a product of commerce, or it can be prepared by reacting an initially non-protonated amine compound of formula (I) in an aqueous medium with a suitable acid.

In the mixing step of the alternative process described above, the first aqueous solution or dispersion is added to the second aqueous solution or dispersion, or vice versa, preferably with agitation, in relative amounts calculated to provide the desired mole ratio of amine compound(s) of formula (I) to exogenous chemical substance in the liquid concentrate composition.

A process for preparing a solid concentrate composition of the invention comprises a first step of mixing an anionic exogenous chemical substance, or a salt thereof, or a mixture of such anionic exogenous chemical substance and salt thereof, in solid particulate form with one or more amine compound(s) of formula (I), together with sufficient water to form a wet mix of consistency suitable for one or more further process steps as described immediately below. Other ingredients, such as for example an adjuvant compound having a molecular structure that comprises a polyoxyethylene chain having about 2 to about 100 ethylene oxide units, can be included in this mixing step. The amine compound(s) of formula (I) and the exogenous chemical substance are mixed in relative amounts calculated to provide the desired mole ratio in the solid concentrate composition. At relatively low mole ratios, for example up to about 0.3:1, the wet mix formed can be suitable for further processing without the presence of any solid inert carrier; but at higher mole ratios it will probably be found necessary to include a solid inert carrier in order to obtain a wet mix of the desired consistency. Suitable amounts of ingredients in the mixing step can be established by one of skill in the art by routine experimentation.

Such a process further comprises a second step of granulating the wet mix to form moist coherent granules, and a third step of drying the granules. Any granulating method known in the art to be suitable for the preparation of water-soluble or water-dispersible granules of an exogenous chemical substance can be used; preferred methods are pan granulation and extrusion granulation. Any drying method known in the art to be suitable for the preparation of water-soluble or water-dispersible granules of an exogenous chemical substance can be used; a preferred method is fluid-bed drying.

Variations of the above processes will be apparent to those of skill in the art. Compositions of the invention are not limited to those made by processes explicitly described herein.

Also provided is a process for eliciting a biological activity in a plant or in a pathogen, parasite or feeding organism present in or on the plant, comprising a step of applying to foliage of the plant a biologically effective amount of a plant treatment composition as provided herein.

Contemplated compositions have numerous benefits and advantages.

When applied to foliage of plants according to the process of the invention, a contemplated composition can provide enhanced biological effectiveness by comparison with commercial standard formulations of the same exogenous chemical substance. At equal application rates of the exogenous chemical substance, a contemplated composition can elicit a greater biological response than a commercial standard formulation. To obtain a given level of biological response, a lower application rate can be required of the exogenous chemical substance when applied in the form of a contemplated composition than in the form of a commercial standard formulation.

A contemplated composition can be biologically effective at a given application rate on a broader spectrum of target species than commercial standard formulations.

A contemplated composition can provide greater reliability or consistency of biological effectiveness in a range of environmental conditions than commercial standard formulations.

A contemplated composition can be more rainfast, i.e., its biological effectiveness is less likely to be reduced by incidence of rain or overhead irrigation occurring within a short period, for example up to about 6 hours, after application, than commercial standard formulations.

A contemplated composition can provide an observable biological response in a shorter period after application than commercial standard formulations.

Specifically, compositions of the invention have surprisingly been found to exhibit biological effectiveness that is superior to, or more cost-effective than, the mono(N-dodecyl-N,N-dimethylammonium) salt of the exogenous chemical substance in the absence of other salts of the exogenous chemical substance and in the absence of an adjuvant compound having a molecular structure that comprises a polyoxyethylene chain having about 2 to about 100 ethylene oxide units, more particularly where the exogenous chemical substance is the herbicide glyphosate. The present invention has also been found to permit surprisingly higher loading of the exogenous chemical substance in a liquid concentrate composition than is possible with the mono(N-dodecyl-N,N-dimethylammonium) salt of the exogenous chemical substance in the absence of other salts of the exogenous chemical substance, more particularly where the exogenous chemical substance is the herbicide glyphosate.

### DETAILED DESCRIPTION OF THE INVENTION

Exogenous chemical substances

Examples of anionic exogenous chemical substances that can be used in compositions of the present invention include, but are not limited to, chemical pesticides (such as herbicides, algicides, fungicides, bactericides, viricides, insecticides, aphicides, miticides, nematicides and molluscicides), plant growth regulators, fertilizers and nutrients, gametocides, defoliants, desiccants, mixtures thereof and the like. Although the disclosure herein relates to “an exogenous chemical substance”, it is to be understood that more than one exogenous chemical substance can be included if desired in a composition of the invention.

A preferred group of anionic exogenous chemical substances consists of those that are normally applied post-emergence to foliage of plants, i.e., foliar-applied anionic exogenous chemical substances. An especially preferred group of foliar-applied anionic exogenous chemical substances consists of those that are systemic in plants, that is, translocated to some extent from their point of entry in the foliage to other parts of the plant where they can usefully exert their desired biological effect.

Especially preferred among these are herbicides, plant growth regulators and nematicides, particularly those that have a molecular weight, excluding counterions, of less than about 300.

Among such compounds, an even more preferred category consists of nematicides such as those disclosed in U.S. Patent No. 5,389,680, the disclosure of which is incorporated herein by reference. Preferred nematicides of this group are 3,4,4-trifluoro-3-butenoic acid or N-(3,4,4-trifluoro-1-oxo-3-butenyl)glycine.

In one embodiment, the exogenous chemical substance is a herbicide. Suitable herbicides include, without restriction, acifluorfen, asulam, benazolin, bentazon, bilanafos, bromacil, bromoxynil, chloramben, clopyralid, 2,4-D, 2,4-DB, dalapon, dicamba, dichlorprop, diclofop, endothall, fenac, fenoxaprop, flamprop, fluazifop, flumiclorac, fluoroglycofen, fomesafen, fosamine, glufosinate, glyphosate, haloxyfop, imazameth, imazamethabenz, imazamox, imazapic, imazapyr, imazaquin, imazethapyr, ioxynil, MCPA, MCPB, mecoprop, methylarsonic acid, naptalam, nonanoic acid, picloram, quinclorac, quizalofop, sulfamic acid, 2,3,6-TBA, TCA and triclopyr. Especially preferred herbicides are those whose molecular structure comprises at least one of each of amine, carboxylate, and either phosphonate or phosphinate functional groups. This category includes the herbicides N-phosphonomethylglycine (glyphosate) and DL-homoalanin-4-yl(methyl) phosphinate (glufosinate). Another preferred group of herbicides are those of the imidazolinone class, including imazameth, imazamethabenz, imazamox, imazapic, imazapyr, imazaquin and imazethapyr.

The invention is illustrated herein by particular reference to glyphosate. Although glyphosate has three acid sites, and can therefore form tribasic salts, preferred aqueous compositions have a pH value not greater than about 8, at which pH value the fraction of glyphosate existing as a tribasic salt is negligibly small. Only the two acid sites that are significantly deprotonated at pH 8 are therefore considered herein. One of these is on the phosphonate moiety, and the other is on the carboxylate moiety, of the glyphosate molecule.

For convenience and brevity herein, glyphosate acid is sometimes referred to as GH₂. Monovalent glyphosate anions, such as predominate for example at around pH 4, are referred to as GH⁻. Divalent glyphosate anions, such as predominate for example at pH 7-8, are referred to as G²⁻.

In plant treatment compositions of the invention, the amount of exogenous chemical substance present, in all forms thereof, is sufficient when applied to foliage of a plant to elicit the desired biological activity. Such compositions are sometimes referred to as “spray compositions”, “sprayable compositions” or “ready-to-use compositions” and typically contain about 0.02% by weight to about 2% by weight of the exogenous chemical substance, expressed as acid equivalent (a.e.). For some purposes such compositions can contain up to about 5% a.e. by weight or even 10% a.e. by weight.

In concentrate compositions of the invention, the amount of exogenous chemical substance present, in all forms thereof, is sufficient, upon dilution, dissolution or dispersion in a suitable volume of water to form a plant treatment composition, and application of the plant treatment composition to foliage of a plant, to elicit the desired biological activity. Liquid concentrate compositions contain about 5% a.e. by weight to about 50% a.e. by weight or more of the exogenous chemical substance, in all forms thereof present. Solid concentrate compositions contain about 5% a.e. by weight to about 75% a.e. by weight or more of the exogenous chemical substance, in all forms thereof present.

As a significant portion of the cost of a packaged concentrate composition is the volume-related cost of packaging, transport and storage, it is desirable to increase to the maximum practicable extent the concentration, or loading, of exogenous chemical substance in the composition. Generally the factor that limits loading of a liquid composition is physical stability of the composition under a range of storage conditions. The upper limit of loading depends on the nature and concentration of other ingredients in the composition and can be readily determined by routine experimentation using procedures known in the art.

In the first embodiment of the invention disclosed above, the exogenous chemical substance is present partly in the form of salt(s) having as the cationic counterion(s) one or more amine compound(s) of formula (I). In the second embodiment disclosed above, such salt(s) are not distinct identifiable component(s) of the composition, the exogenous chemical substance being introduced in the form of a salt having a cationic counterion of molecular weight lower than about 100, or a mixture of such salts. In preferred salts of this second embodiment the cationic counterion is monovalent and is selected from alkali metal cations, ammonium cations, and organic ammonium and sulfonium cations having in total 1-6 carbon atoms.

In particular where the exogenous chemical substance is glyphosate, illustrative cationic counterions suitable for use in compositions of the second embodiment of the invention are sodium, potassium, ammonium, dimethylammonium, isopropylammonium, monoethanolammonium and trimethylsulfonium cations.

Throughout this specification, all references to an exogenous chemical substance in general can be taken to apply to glyphosate in particular, unless the context demands otherwise.

Amine compounds of formula (I)

As indicated above, compositions of the invention contain one or more amine compound(s) each having the formula (I)

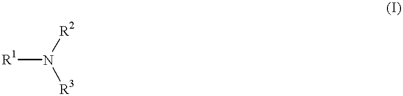

wherein R¹ is a hydrocarbyl group, preferably a linear hydrocarbyl chain, having 6 to about 22 carbon atoms, and R² and R³ are independently C₁₋₅ hydrocarbyl groups. In the formula for the amine compound, R¹ preferably has at least 10, more preferably at least 12, and most preferably at least 14, carbon atoms. R² and R³ are preferably C₁₋₃ alkyl, and most preferably methyl, groups. Even more preferably, R¹ is a saturated or unsaturated chain having 14, 16 or 18 carbon atoms and R² and R³ are methyl groups. Typically the R¹ chain is derived from lauric, myristic, palmitic, stearic, oleic, linolenic, linoleic or other natural fatty acids. In especially preferred amine compounds the R¹ chain is derived from myristic, palmitic, stearic or oleic acid.

Normally, by design, only one amine compound of formula (I) is used in a composition of the invention. However, as the R¹ group of the amine compound is often derived from natural sources such as coconut oil, palm oil, beef tallow, etc., commercial preparations of such amine compounds can contain a range of hydrocarbyl chain lengths, sometimes with varying degrees of unsaturation. For example, a “cocoalkyl” compound has R¹ groups derived from coconut oil, such groups being predominantly C₁₂ saturated (lauryl or dodecyl) and C₁₄ saturated (myristyl or tetradecyl) chains. Similarly, a “tallowalkyl” compound has R¹ groups derived from tallow, such groups being predominantly C₁₈ unsaturated (oleyl) and saturated (stearyl or octadecyl) and C₁₆ saturated (cetyl or hexadecyl) chains. Thus when amounts of an amine compound of formula (I) are specified herein, it is to be understood that such amounts are inclusive of other amine compounds of formula (I) present in the amine compound preparation used.

Particularly preferred examples of amine compounds of formula (I) include N-cocoalkyl-N,N-dimethylamine, available as Noram™ DMC D, N-stearyl-N,N-dimethylamine, available as the principal component of Noram™ DMSH D, N-oleyl-N,N-dimethylamine, available as Noram™ DMO D, and N-tallowalkyl-N,N-dimethylamine, available as NoramTm DMS D, all from CECA S.A. of Paris, France.

As indicated herein, plant treatment compositions of the invention satisfy at least one of three criteria:

(i) the mole ratio of amine compound(s) of formula (I) to the exogenous chemical substance is about 0.05 to about 0.8:1, preferably about 0.1:1 to about 0.5:1; and/or

(ii) the hydrocarbyl group represented by R¹ in the amine compound(s) of formula (I) has 14 to about 22 carbon atoms; and/or

(iii) an adjuvant compound having a molecular structure that comprises a polyoxyethylene chain having about 2 to about 100 ethylene oxide units is present in the composition in a weight ratio to the exogenous chemical substance of about 1:10 to about 10:1, preferably about 1:3 to about 3:1.

The second of these criteria, namely that the hydrocarbyl group represented by R¹ in the amine compound(s) of formula (I) has 14 to about 22 carbon atoms, is satisfied where the exogenous chemical substance is at least partly neutralized with a preparation of N-cocoalkyl-N,N-dimethylamine, for example the product sold as Noram™DMC D. Although the predominant hydrocarbon chain length in the fatty acids of coconut oil, the raw material from which cocoalkyl groups are obtained, is C₁₂, the maximum content of C₁₂ and shorter chains in coconut oil is 70%. Thus at least 30% of cocoalkyl groups are of C₁₄ or longer chain length. See R. T. Morrison & R. N. Boyd, Organic Chemistry, 6th Edition (1992), Prentice Hall, page 1121. Surprisingly, a composition comprising the mixture of salts obtained by neutralizing glyphosate with N-cocoalkyl-N,N-dimethylamine has been found to exhibit greater herbicidal effectiveness than the composition comprising the pure N-dodecyl-N,N-dimethylammonium salt of glyphosate disclosed in the above-cited European Patent Application No. 0 124 351. It is believed that this superior effectiveness is related to the contribution of C₁₄ and longer chain length alkyl groups in N-cocoalkyl-N,N-dimethylamine, which are missing from the pure N-dodecyl-N,N-dimethylammonium salt. Furthermore, it has surprisingly been found that a liquid aqueous concentrate composition comprising the mixture of salts obtained by neutralizing glyphosate with N-cocoalkyl-N,N-dimethylamine can be loaded to a significantly higher glyphosate a.e. concentration than is possible with a composition comprising the pure N-dodecyl-N,N-dimethylammonium salt of glyphosate disclosed in the above-cited European Patent Application No. 0 124 351. It is believed that this potential for higher loading is related at least in part to the presence of C₁₄ and longer-chain alkyl groups in N-cocoalkyl-N,N-dimethylamine, which are missing from the pure N-dodecyl-N,N-dimethylammonium salt.

An amine compound of formula (I) is sometimes represented herein in its protonated (cationic) form, or when accompanied by an anionic exogenous chemical substance or other anionic counterion, as A⁺. References herein to an amount of A⁺ present should be understood to include any amount that may be present of unprotonated amine compound coexisting with an acid such as the exogenous chemical substance in its acid form.

In compositions of the invention wherein the amine compound(s) of formula (I) are introduced in the form of salt(s) thereof with an acid other than the exogenous chemical substance, each amine compound is protonated and accompanied in aqueous solution or dispersion by an anionic counterion. Suitable counterions include without limitation chloride, bromide, iodide, sulfate, ethosulfate, phosphate, acetate, propionate, succinate, lactate, citrate and tartrate.

In such compositions, salt(s) of the amine compound(s) wherein the anionic counterion is the exogenous chemical substance itself can theoretically be present. Such a salt would be expected to behave in an aqueous medium as an amphiphilic species; for example, it would be expected, above a certain concentration, to self-assemble as supramolecular aggregates containing some fraction of the exogenous chemical substance present in the composition as a whole. However, it is not required by the present invention that such an amphiphilic salt be identifiably present as a distinct species, or that supramolecular aggregates are identifiably present, or that, if present, such supramolecular aggregates contain such amphiphilic salt.

Thus, in the second embodiment of the invention disclosed above, either substantially no supramolecular aggregates are present as determined by techniques disclosed herein, or supramolecular aggregates are present but contain no substantial amount of salt(s) of the amine compound(s) wherein the anionic counterion is the exogenous chemical substance, as determined by techniques known in the art.

For example, a composition of the invention can be made by adding a low molecular weight salt of an anionic exogenous chemical substance, such as isopropylammonium glyphosate, to an aqueous colloidal dispersion of supramolecular aggregates containing the hydrochloric acid salt of an amine compound of formula (I), such as N-oleyl-N,N-dimethylammonium chloride. Using a chloride selective electrode, the concentration of free chloride ions in the aqueous medium can be determined before and after addition of the glyphosate salt. If the concentration of chloride ions in the aqueous medium does not increase, it can be concluded that substantially none of the chloride located in the supramolecular aggregates has been replaced by glyphosate and that therefore no substantial amount of glyphosate is located in the supramolecular aggregates. In this instance the composition conforms to the second embodiment of the invention. More likely an increase in chloride ion concentration in the aqueous medium will be recorded, from which it can be concluded that ion exchange has occurred in the supramolecular aggregates with the result that an amphiphilic salt of the amine compound of formula (I) with glyphosate is present in those aggregates. In this instance, the composition conforms to the first rather than the second embodiment of the invention.

In the first embodiment, a composition of the invention contains amphiphilic salt(s) formed by neutralization of a first molar amount X¹ of the anionic exogenous chemical substance by one or more amine compound(s) of formula (I). Such compositions are disclosed herein as comprising a first and optionally a second and/or third molar amount of the exogenous chemical substance and are more fully described below.

Amphiphilic salt(s) of the first molar amount of the exogenous chemical substance

Compositions of the first embodiment of the invention contain supramolecular aggregates comprising amphiphilic salt(s) formed by neutralization of a first molar amount X¹ of the anionic exogenous chemical substance by one or more amine compound(s) of formula (I).

For example, an amphiphilic monobasic salt of glyphosate with cations derived from an amine compound of formula (I) can be represented by formula (III):

[GH⁻] [A⁺] (III)

and a dibasic salt by formula (IV):

[G²⁻][A⁺]₂ (IV)

A mixture of amphiphilic salts of formulas (III) and (IV) can be present, optionally together with glyphosate acid GH₂ and/or with unprotonated amine compound.

Typically, even where the exogenous chemical substance is glyphosate, the monobasic salt predominates in a composition of the first embodiment, the amount of A⁺ present (including unprotonated amine compound coexisting with acid) being preferably not greater than about 1 mole per mole of exogenous chemical substance. In general, to provide the full benefits of the present invention, the amount of A⁺ present should be sufficient to neutralize not less than about 10% of the exogenous chemical substance present, i.e., X¹ as a fraction of (X¹+X²+X³) is preferably at least about 0.05, preferably at least about 0.1.

As it is an objective to prepare a stable concentrate composition with a high loading of the exogenous chemical substance on an acid equivalent basis, it is preferred that X¹ as a fraction of (X¹+X²+X³) be substantially less than 1, but nevertheless sufficient to provide biological effectiveness at least equal to that of an aqueous dispersion of the pure N-dodecyl-N,N-dimethylammonium salt of the exogenous chemical substance, i.e., a composition of that salt wherein X² and X³ are close to zero. Generally this means that X¹ as a fraction of (X¹+X²+X³) is preferably about 0.1 to about 0.5, though in some situations this fraction can be even lower. As the amine compound(s) from which the A⁺ cations are derived have relatively high molecular weight, it is difficult to achieve the desired high loading except where relatively low molecular weight B⁺ cations, for example sodium, ammonium or isopropylammonium cations, predominate.

For clarity, it is re-emphasized that the molar amounts X¹, X² and X³ as defined in the present specification and in the claims hereof are not determined by the amounts of the exogenous chemical substance which have donated protons to amine compound(s) of formula (I) or to other base(s). Instead, these molar amounts are determined simply by the relative molar amounts of amine compound(s) of formula (I) and of other base(s) present in the composition, provided there is no molar excess of base. This may be best explained by an illustrative example.

In this example, a plant treatment composition of the invention contains glyphosate at a concentration, in all acid and salt forms present, of 16.9 g a.e./l, i.e., 100 MM. Also present is N-lauryl-N,N-dimethylamine at a concentration (in total of protonated and unprotonated forms) of 5.3 g/l, i.e., 25 mM, and sodium ions derived from sodium hydroxide at a concentration of 60 mM. Expressed as molar concentration, the first molar amount X¹ of the glyphosate is in this example equal by definition to the molar amount of N-lauryl-N,N-dimethylamine present, or 25mM. The second molar amount X² of the glyphosate is equal by definition to the molar amount of sodium ions present, or 60 mM. The third molar amount X³ of the glyphosate is determined by difference, i.e., (100 mM - 25 mM - 60 mM)=15mM.

If a molar excess of base is present, the molar amount X3 is defined to be zero.

Where the exogenous chemical substance is glyphosate, it is preferred that the total molar amount of base(s) added is not less than about half, and not greater than about two times, the total molar amount of glyphosate present. In other words, in a preferred composition:

if the total molar amount of glyphosate present, in all salt and acid forms, is g;

if the total molar amount of amine compound(s) of formula (I) present, in protonated and unprotonated forms, is a;

if the total molar amount of base(s) other than an amine compound of formula (I) present, in all forms, is b;

and if (a+b)/g is represented by Z; then typically

(i) 0.01 <a/g<2;

(ii) 0<b/g<1.99; and

(iii) 0.5<Z<2.

It is believed that in a typical concentrate liquid composition of the first embodiment of the invention, a significant fraction, for example more than about 10% by weight, preferably more than about 50% by weight, of the amphiphilic salt(s) comprising A⁺ cations are located in supramolecular aggregates which are colloidally dispersed in the liquid, preferably aqueous, medium. This can be verified by isolating the supramolecular aggregates from the medium by techniques known in the art such as filtration or centrifugation, and analyzing the two components thus obtained, or by other techniques disclosed herein. Upon dilution of a concentrate composition in water to form a plant treatment composition, more of the amphiphilic salt(s) may be partitioned in the aqueous medium; however it is presently believed that even under these circumstances, in preferred compositions, most or substantially all of the amphiphilic salt(s) remain in the supramolecular aggregates.

Without being bound by theory, it is believed that location of a significant proportion of an exogenous chemical substance in supramolecular aggregates, as a result of the amphiphilic nature of salt(s) made by neutralizing the exogenous chemical substance with one or more amine compound(s) of formula (I), accounts at least in part for the superior biological effectiveness of compositions of the invention when applied to foliage of plants, through improved penetration into and through cuticles.

Salt(s) of the second molar amount of the exogenous chemical substance

The second molar amount X² of the exogenous chemical substance is present as one or more salt(s) other than a salt comprising A⁺ cations. Such second molar amount can be present predominantly in supramolecular aggregates, predominantly in the aqueous medium, or in both. Such salt(s) can be amphiphilic or non-amphiphilic. Where a salt of the second molar amount is an amphiphilic salt, it is believed that it will be predominantly located in supramolecular aggregates.

The cation(s) of salt(s) of the second molar amount of the exogenous chemical substance are typically provided by base(s) other than an amine compound of formula (I). Preferred such cations are monovalent cations including (i) alkali metal, for example sodium and potassium, cations, (ii) ammonium cations, (iii) organic ammonium and sulfonium cations having in total 1-6 carbon atoms, and (iv) trialkylammonium cations wherein alkyl groups each have 4-6 carbon atoms. An illustrative exception is the case where all of the exogenous chemical substance present is neutralized by N-cocoalkyl-N,N-dimethylamine and no other base is provided. In this case the first molar amount of the exogenous chemical substance can be considered as being neutralized by that fraction (at least about 30%) of the N-cocoalkyl-N,N-dimethylamine wherein the alkyl chain length is C₁₄ and longer, and the second molar amount as being neutralized by that fraction (up to about 70%) of the N-cocoalkyl-N,N-dimethylamine wherein the alkyl chain length is C₁₂ and shorter.

Particular examples of cations useful in salts of the second molar amount of the exogenous chemical substance include sodium, ammonium, dimethylammonium, isopropylammonium, monoethanolammonium, trimethylsulfonium and trihexylammonium cations.

Cation(s) of salt(s) of the second molar amount of an exogenous chemical substance are sometimes referred to collectively herein as B⁺. A monobasic salt of glyphosate, or a mixture of monobasic salts of glyphosate, with such cations can therefore be represented by formula (V):

[GH⁻][B⁺] (V)

and a dibasic salt or mixture thereof by formula (VI):

[G²⁻][B⁺]₂ (VI)

References herein to an amount of B⁺ present should be understood to include any amount that may be present of un-ionized or undissociated base coexisting with the exogenous chemical substance in its acid form. For most purposes, even where the exogenous chemical substance is glyphosate, it is preferred that the monobasic salt predominate in the composition.

The third molar amount of the exogenous chemical substance

Optionally, a third molar amount X³ of the exogenous chemical substance can be present in the form of the acid, unneutralized by any base. Typically, X³ accounts for not more than about half of the total molar amount of the exogenous chemical substance present in all its forms. Preferably, X³ is small by comparison with (X¹+X²), for example X³ as a fraction of (X¹+X²+X³) is not greater than about 0.1.

Mole ratio of amine compound(s) of formula (I) to exogenous chemical substance

Where the amine compound(s) of formula (I) have a hydrocarbyl group R¹ having 14 or more carbon atoms, or where a polyoxyethylene compound as more fully described below is additionally present in the composition, the mole ratio of amine compound(s) of formula (I) to the exogenous chemical substance is typically about 0.01:1 to about 2:1. In some circumstances, a lower mole ratio than 0.01: 1, for example 0.005:1 or even 0.001:1, can be found useful and compositions having such a low mole ratio are not excluded from the present invention if at least one of the benefits or advantages indicated herein is realized. Preferably, however, the mole ratio is in the range from about 0.03:1 to about 0.8:1.

Where the amine compound(s) of formula (I) have a hydrocarbyl group R¹ that is not restricted to one having 14 or more carbon atoms, and in the absence of a polyoxyethylene compound as more fully described below, the mole ratio of amine compound(s) of formula (I) to the exogenous chemical substance is about 0.05:1 to about 0.8:1. In one illustrative preferred embodiment, the mole ratio is not less than 0.05:1 but is less than 0.1:1. In another illustrative preferred embodiment, the mole ratio is greater than 0.1:1 and less than 0.2:1. In yet another illustrative preferred embodiment, the mole ratio is greater than 0.2:1 and less than 0.3:1, for example around 0.25:1. In yet another illustrative preferred embodiment, the mole ratio is greater than 0.3:1 but not greater than 0.8:1, for example around 0.5:1. In general, the most preferred mole ratios are in the range from about 0.1:1 to about 0.5:1.

Characteristics of a contemplated composition

By selecting the particular amine compounds disclosed herein, compositions of the invention exhibit a high degree of physical stability. Where colloidal dispersions of supramolecular aggregates are formed, these dispersions have surprisingly been found to exhibit a high degree of physical stability. The supramolecular aggregates themselves, as well as the composition as a whole, are physically stable, a feature which is of great benefit in the handling, storage and use of compositions of the invention.

A particularly unexpected discovery is that supramolecular aggregates if present substantially maintain their structural integrity even upon dilution to levels useful for direct application to foliage of plants. This structural integrity is generally not dependent on the presence of dispersants or emulsifying agents, or indeed of any surfactants other than the amine compound(s) of formula (I) or amphiphilic salt(s) thereof. However, as indicated below, surfactants other than an amine compound of formula (I) or an amphiphilic salt thereof can optionally be present in a composition of the invention.

Certain aqueous concentrate compositions of the invention can be described as stable colloidal dispersions of supramolecular aggregates. By “stable” in this context it is meant that no phase separation occurs during storage of a composition without agitation at 20-25° C. for 48 hours. A stability test is described more fully in the Examples herein. The more desirable aqueous concentrate compositions of the invention are colloidal dispersions in which no phase separation occurs during storage without agitation at constant or varying temperatures from about 10° C. to about 40° C. for 48 hours, even more desirably from about 0° C. to about 50° C. for 7 days, and most desirably about -10° C. to about 60° C. for 30 days. Stability at elevated temperatures for short time periods provides a good indication of long-term stability under normal storage conditions; it is contemplated that certain concentrate compositions of the invention will be stable for periods of 1 year or more under normal storage conditions.

Supramolecular aggregates of compositions of the invention are sometimes referred to as nanoparticles. The term “nanoparticle” has no universally accepted definition in the art; however as used herein the term refers to bodies whose longest dimension is of a size up to about 1 μm (1000 nm), and includes bodies that are not solid particulates.

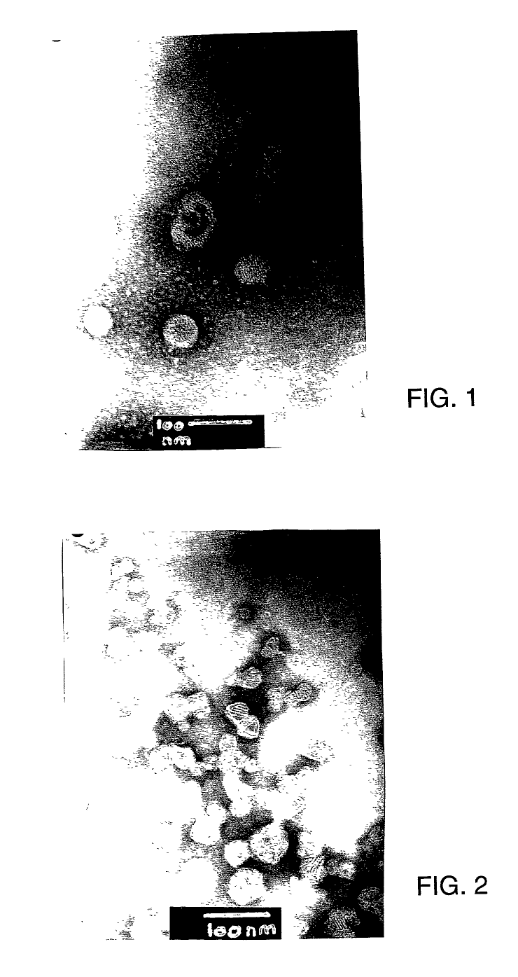

The supramolecular aggregates present in compositions of the invention are of at least two types. A first type is of a size too small to be detectable by the transmission electron microscopy technique used in certain examples herein and to provide the micrographs of FIGS. 1 and 2 hereof, but measurable by other techniques known in the art such as dynamic light scattering. Supramolecular aggregates of this first type have characteristics of more or less spherical micelles, colloidal dispersions of which in an aqueous medium are variously referred to as emulsions, microemulsions, micellar emulsions and micellar solutions. Unless the context demands otherwise, the term “emulsion” as descriptive of a composition of the present invention is herein reserved for compositions where the micelles or other supramolecular aggregates contain, in addition to amphiphilic salt(s) of an exogenous chemical substance, an oil as described in greater detail below. In the absence of such oil, the micelles, or supramolecular aggregates of the first type, typically have a mean diameter of about 1 to about 10 nm, most commonly about 2 to about 5 nm.

In common with other micellar dispersions, compositions of the invention exhibit a critical micelle concentration (CMC), which is a concentration of an amphiphilic material below which molecules of the amphiphilic material do not aggregate to form micelles. Compositions of the invention preferably have a CMC not greater than about 1000 μM, more preferably not greater than about 100 μM. A method for determining the CMC of a composition of the invention is provided in the Examples herein.

Amphiphilic salts of glyphosate with a tertiary amine compound of formula (I) typically have CMC values much lower than corresponding salts with a primary amine having the same R¹ group.

It is, at least in part, the very low CMC of preferred compositions of the invention that enables the supramolecular aggregates, or micelles, to survive dilution to the levels useful as spray compositions. For example, an aqueous concentrate composition containing 169 g/l (100 mM) glyphosate, all in the form of the amphiphilic mono(N-cocoalkyl-N,N-dimethylammonium) salt, when diluted 100 times with water, provides a spray composition having a 10 mM concentration of the amphiphilic salt. Even if only 1% of the glyphosate in the concentrate composition is in the form of this amphiphilic salt, with the remaining glyphosate in the form of non-amphiphilic salts, the concentration of the amphiphilic salt following 100-fold dilution with water is, at 100 μM, still above the CMC for this salt (37 μM), so that micelles will still be present.

Aqueous compositions of the invention can also contain supramolecular aggregates of a second type. These are typically 20-100 nm in size and, as illustrated in FIGS. 1 and 2, are normally spherical. They are too large to be simple micelles and are believed to be vesicular, multilamellar or liposome-like in structure.

Typically, aqueous concentrate compositions of the invention are clear or slightly turbid.

Other ingredients

Compositions of the invention can contain agriculturally acceptable materials other than an exogenous chemical substance or a salt thereof as described herein.

For example, more than one exogenous chemical substance can be included. An additional anionic exogenous chemical substance can be included, selected for example from those hereinbefore listed. Alternatively or in addition, an exogenous chemical substance that is other than anionic as defined herein can be included. For example, a glyphosate composition of the invention can optionally contain, in addition to glyphosate, an anionic herbicidal compound such as acifluorfen, asulam, benazolin, bentazon, bialaphos, clopyralid, 2,4-D, 2,4-DB, dalapon, dicamba, dichlorprop, diclofop, fenoxaprop, flamprop, fluazifop, fluoroglycofen, fluroxypyr, fomesafen, fosamine, glufosinate, haloxyfop, imazameth, imazamethabenz, imazamox, imazapic, imazapyr, imazaquin, imazethapyr, MCPA, MCPB, mecoprop, methylarsonic acid, nonanoic acid, picloram, sulfamic acid, 2,3,6-TBA, TCA and triclopyr. Such additional anionic compound is present as salt(s) comprising A⁺, and optionally B⁺, cations as described herein. Similarly, a composition of the invention containing salts of an anionic herbicide can optionally contain a herbicidal compound that is other than anionic, such as for example an ester derivative of an anionic herbicide, or a herbicide selected from acetochlor, aclonifen, alachlor, ametryn, amidosulfuron, anilofos, atrazine, azafenidin, azimsulfuron, benfluralin, benfuresate, bensulfuron-methyl, bensulide, benzofenap, bifenox, bromobutide, bromofenoxim, butachlor, butamifos, butralin, butroxydim, butylate, cafenstrole, carbetamide, carfentrazone-ethyl, chlomethoxyfen, chlorbromuron, chloridazon, chlorimuron-ethyl, chlorotoluron, chlornitrofen, chlorotoluron, chlorpropham, chlorsulfuron, chlorthal-dimethyl, chlorthiamid, cinmethylin, cinosulfuron, clethodim, clodinafop-propargyl, clomazone, clomeprop, cloransulam-methyl, cyanazine, cycloate, cyclosulfamuron, cycloxydim, cyhalofop-butyl, daimuron, desmedipham, desmetryn, dichlobenil, diclofop-methyl, diflufenican, dimefuron, dimepiperate, dimethachlor, dimethametryn, dimethenamid, dinitramine, dinoterb, diphenamid, dithiopyr, diuron, EPTC, esprocarb, ethalfluralin, ethametsulfuron-methyl, ethofumesate, ethoxysulfuron, etobenzanid, fenoxaprop-ethyl, fenuron, flamprop-methyl, flazasulfuron, fluazifop-butyl, fluchloralin, flumetsulam, flumiclorac-pentyl, flumioxazin, fluometuron, fluorochloridone, fluoroglycofen-ethyl, flupoxam, flurenol, fluridone, fluroxypyr-l-methylheptyl, flurtamone, fluthiacet-methyl, fomesafen, halosulfuron, haloxyfop-methyl, hexazinone, imazosulfuron, indanofan, isoproturon, isouron, isoxaben, isoxaflutole, isoxapyrifop, lactofen, lenacil, linuron, mefenacet, metamitron, metazachlor, methabenzthiazuron, methyldymron, metobenzuron, metobromuron, metolachlor, metosulam, metoxuron, metribuzin, metsulfuron, molinate, monolinuron, naproanilide, napropamide, naptalam, neburon, nicosulfuron, norflurazon, orbencarb, oryzalin, oxadiargyl, oxadiazon, oxasulfuron, oxyfluorfen, pebulate, pendimethalin, pentanochlor, pentoxazone, phenmedipham, piperophos, pretilachlor, primisulfuron, prodiamine, prometon, prometryn, propachlor, propanil, propaquizafop, propazine, propham, propisochlor, propyzamide, prosulfocarb, prosulfuron, pyraflufen-ethyl, pyrazolynate, pyrazosulfuron-ethyl, pyrazoxyfen, pyributicarb, pyridate, pyriminobac-methyl, quinclorac, quinmerac, quizalofop-ethyl, rimsulfuron, sethoxydim, siduron, simazine, simetryn, sulcotrione, sulfentrazone, sulfometuron, sulfosulfuron, tebutam, tebuthiuron, terbacil, terbumeton, terbuthylazine, terbutryn, thenylchlor, thiazopyr, thifensulfuron, thiobencarb, tiocarbazil, tralkoxydim, triallate, triasulfuron, tribenuron, trietazine, trifluralin, triflusulfuron and vemolate.

Exogenous chemical substances useful in compositions of the invention can be selected from those listed in standard reference works such as The Pesticide Manual, 11th Edition, British Crop Protection Council (1997), and Farm Chemicals Handbook '97, Meister Publishing Company (1997).

Various agriculturally acceptable adjuvants or excipient substances can also be included, whether or not their purpose is to contribute directly to the biological effectiveness of an exogenous chemical substance in a treated plant. For example, where the exogenous chemical substance is a herbicide, liquid nitrogen fertilizer or ammonium sulfate can be included in the composition. In some instances it can be desirable to include microencapsulated acid in the composition, to lower the pH of a spray solution on contact with foliage.

Other optional components of compositions of the invention include agents to modify color, odor, viscosity, gelling properties, freezing point, stability or texture.

One or more surfactant(s), other than an amine compound of formula (I) or an amphiphilic salt thereof, can also be included in a contemplated composition. A wide range of surfactants is available to the formulator of exogenous chemical substances and can be selected readily from standard works such as McCutcheon's Emulsifiers and Detergents, 1998 Edition, MC Publishing Company, or Handbook of Industrial Surfactants, 2nd Edition, Gower (1997).

There is no restriction on the type or chemical class of surfactant that can be used. Nonionic, anionic, cationic and amphoteric types, or combinations of more than one of these types, are all useful in particular situations.

Many surfactants useful herein have a chemical structure that comprises one or more moieties each consisting of a single C₂₋₄ alkylene oxide unit or a polymerized or copolymerized chain of C₂₋₄ alkylene oxide units. Such surfactants are referred to as polyoxyalkylene surfactants and include nonionic, anionic, cationic and amphoteric types. Polyoxyalkylene surfactants useful in presently contemplated compositions contain about 2 to about 100 C₂₋₄ alkylene oxide units. In preferred polyoxyalkylene surfactants the alkylene oxide units form one or more chain(s) of either ethylene oxide or copolymerized ethylene oxide and propylene oxide, each chain of alkylene oxide units having a terminal hydrogen or a C₁₋₄ alkyl or C₂₋₄ acyl end-cap.

Hydrophobic moieties of surfactants useful in compositions of the invention can be essentially hydrocarbon-based, in which case the hydrophobic moieties are typically C₈₋₂₄, preferably C₁₂₋₁₈, alkyl, alkenyl, alkylaryl, alkanoyl or alkenoyl chains. These chains can be linear or branched. Alternatively, the hydrophobic moieties can contain silicon atoms, for example in the form of siloxane groups such as heptamethyltrisiloxane groups, or fluorine atoms, for example as partially fluorinated alkyl or perfluoroalkyl chains.

Among nonionic surfactants, especially preferred classes include polyoxyethylene alkyl, alkenyl, alkynyl or alkylaryl ethers, such as polyoxyethylene primary or secondary alcohols, alkylphenols or acetylenic diols; polyoxyethylene alkyl or alkenyl esters, such as ethoxylated fatty acids; sorbitan alkylesters, whether ethoxylated or not; glyceryl alkylesters; sucrose esters; and alkyl polyglycosides. Representative specific examples of such nonionic surfactants include polyoxyethylene (9) nonylphenol, Neodol™25-7 of Shell (a polyoxyethylene (7) C₁₂₋₁₅ linear primary alcohol), Plurafac™A-38 of BASF (a polyoxyethylene (27) C₁₆₋₁₈ linear primary alcohol), TergitolTM 15-S-9 of Union Carbide ( a polyoxyethylene (9) C₁₂₋₁₅ secondary alcohol), Tween™20 of ICI (a polyoxyethylene (20) sorbitan monolaurate), Surfynol™465 of Air Products ( a polyoxyethylene (10) 2,4,7,9-tetramethyl-5-decyne-4,7-diol) and AgriMul™PG-2069 of Henkel (a C₉₋₁₁ alkyl polyglucoside).

When included, nonionic surfactants are preferably present in an adjuvant amount, i.e., an amount sufficient to provide visibly improved biological effectiveness of the exogenous chemical substance by comparison with a composition lacking such surfactants. “Visibly improved” in the present context means that, in a side-by-side comparison, a difference in biological effectiveness in favor of the composition containing the nonionic surfactant(s) would be evident to an experienced technician in the art relating to the particular class of exogenous chemical substance being applied, for example a weed scientist in the case where the exogenous chemical substance is a herbicide.

Preferably, one or more nonionic surfactant(s), if included, are present in the composition in a ratio of total weight of such surfactant(s) to weight of the anionic exogenous chemical substance, expressed as acid equivalent, of about 1:10 to about 10:1, preferably about 1:3 to about 3: 1, though greater or lesser amounts can be found useful in particular situations.

Among anionic surfactants, especially preferred classes include fatty acids; alkyl-substituted benzene sulfonates and diphenylether disulfonates; naphthalene sulfonates; acyl isethionates, sarcosinates, sulfosuccinates, semisulfosuccinates, sulfosuccinamates and taurates; alkane and α-olefin sulfonates; sulfates and sulfonates of oils and fatty esters; sulfates, sulfonates, and phosphate mono- and diesters of alcohols, alkylphenols, polyoxyethylene alcohols and polyoxyethylene alkylphenols; and carboxylates of polyoxyethylene alcohols and polyoxyethylene alkylphenols. These can be used in their acid form or as salts, for example sodium, potassium or ammonium salts.

In a particular embodiment of the present invention, a plant treatment composition for application to foliage of a plant to elicit a biological response is provided, comprising water, wherein are dissolved or dispersed an anionic exogenous chemical substance and one or more amine compound(s) each having the formula (I)

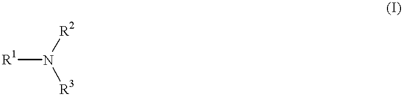

wherein R¹ is a hydrocarbyl group, preferably a linear hydrocarbyl chain, having 6 to about 22 carbon atoms, and R² and R³ are independently C₁₋₅ hydrocarbyl groups; wherein the exogenous chemical substance is present in the composition in an amount sufficient to elicit the biological response when the composition is applied to the foliage of the plant at a rate of about 10 to about 1000 liters per hectare (l/ha); wherein the amine compound(s) of formula (I) are present in the composition typically in a mole ratio to the exogenous chemical substance of about 0.01:1 to about 2: 1; the composition further comprising an anionic surfactant in a mole ratio of the anionic surfactant to the amine compound(s) of formula (I) of about 0.1:1 to about 10:1, preferably about 0.5:1 to about 2:1 and most preferably about 0.8:1 to about 1.2:1.

Preferred anionic surfactants useful in this embodiment of the invention are selected from the classes listed above having hydrophobic C₈₋₂₄, preferably C₁₂₋₁₈, alkyl, alkenyl, acyl or alkylaryl groups. In anionic surfactants having polyoxyethylene chains, such chains preferably have 1 to about 60 ethylene oxide units.

Among cationic surfactants, especially preferred classes include polyoxyethylene tertiary alkylamines or alkenylamines, such as ethoxylated fatty amines, quaternary ammonium surfactants and polyoxyethylene alkyletheramines. Representative specific examples of such cationic surfactants include polyoxyethylene (5) cocoamine, polyoxyethylene (15) tallowamine, distearyldimethylammonium chloride, N-dodecylpyridine chloride and polyoxypropylene (8) oxyethylene trimethylammonium chloride. Particularly preferred polyoxyethylene alkyletheramines are those disclosed in International Publication No. WO 96/32839.

Many cationic quaternary ammonium surfactants of diverse structures are known in the art to be useful in combination with glyphosate and other exogenous chemical substances and can be used in compositions contemplated herein; such quaternary ammonium surfactants have formula (VII):

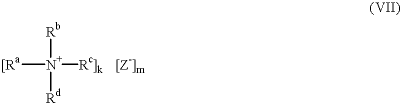

where Z⁻ is a suitable anion such as chloride, bromide, iodide, acetate, salicylate, sulfate or phosphate; k and m are integers such that the positive electrical charges on cations balance the negative electrical charges on anions; and options for R^{a}, R^{b}, R^{c} and R^{d} include, without limitation, the following:

(i) R^{a} is a benzyl or C₈₋₂₄, preferably a C₁₂₋₁₈, alkyl or alkenyl group, and R^{b}, R^{c} and R^{d} are independently C₁₋₄ alkyl, preferably methyl, groups;

(ii) R^{a} and R^{b} are independently C₈₋₂₄, preferably C₁₂₋₁₈, alkyl or alkenyl groups, and R^{c} and R^{d} are independently C₁₋₄ alkyl, preferably methyl, groups;

(iii) R^{a} is a C₈₋₂₄, preferably a C₁₂₋₁₈, alkyl or alkenyl group, R^{b} is a polyoxyalkylene chain having about 2 to about 100 C₂₋₄ alkylene oxide units, preferably ethylene oxide units, and RC and Rd are independently C₁₋₄ alkyl, preferably methyl, groups;

(iv) R^{a} is a C₈₋₂₄, preferably a C₁₂₋₁₈, alkyl or alkenyl group, R^{b} and R^{c} are polyoxyalkylene chains having in total about 2 to about 100 C₂₋₄ alkylene oxide units, preferably ethylene oxide units, and R^{d} is a C₁₋₄ alkyl, preferably a methyl, group; or

(v) R^{a} is a polyoxyalkylene chain having about 2 to about 100 C₂₋₄ alkylene oxide units in which C₃₋₄ alkylene oxide units, preferably propylene oxide units, predominate, and R^{b}, R^{c} and R^{d} are independently C₁₋₄ alkyl, preferably methyl or ethyl, groups. Particularly preferred quaternary ammonium surfactants of this type are those disclosed in U.S. Pat. No. 5,464,807.

In a preferred embodiment of the present invention, an amphiphilic quaternary ammonium compound, or mixture of such compounds, is present, having formula (VIII):

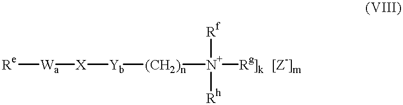

wherein R^{e} is a hydrocarbyl or haloalkyl group having about 6 to about 22 carbon atoms; W and Y are independently O or NH; a and b are independently 0 or 1 but at least one of a and b is 1; Xis CO, SO or SO₂; n is 2to4; R^{f}, R^{g} and R^{h} are independently C₁₋₄ alkyl; and k, m and Z⁻ have the same meanings as in formula (VII). R^{e} in one particular embodiment is a hydrocarbyl group having about 12 to about 18 carbon atoms. R^{e} can also be fluorinated. In one specific embodiment, R^{e} is perfluorinated, and preferably has about 6 to about 12 carbon atoms. In one particularly preferred embodiment, R^{e} is a saturated perfluoroalkyl group having about 6 to about 12 carbon atoms, X is CO or SO₂, Y is NH, a is 0, b is 1, n is 3, R^{f}, R^{g} and R^{h} are methyl groups, k and m are each 1, and Z⁻ is a chloride, bromide or iodide anion.

Sulfonylamino compounds of formula (VIII), i.e., those wherein X is SO₂, Y is NH, a is 0 and b is 1, are especially preferred. Suitable examples include 3-(((heptadecafluorooctyl)sulfonyl)amino)-N,N,N-trimethyl-1-propaminium iodide, available for example as Fluorad™FC-135 from 3M Company, and the corresponding chloride. It is believed that Fluorad™FC-754 of 3M Company comprises the corresponding chloride.

When included, amphiphilic quaternary ammonium compound(s) of formula (VIII) are preferably present in an adjuvant amount as defined above in the context of nonionic surfactants. Preferably, one or more amphiphilic quaternary ammonium compound(s) of formula (VIII), if included, are present in the composition in a ratio of total weight of such compound(s) to weight of the anionic exogenous chemical substance, expressed as acid equivalent, of about 1:100 to about 1:3. Suitable concentrations of a compound of formula (VIII) are about 0.001% to about 1% by weight in a plant treatment composition, and about 0.01% to about 10% by weight in a liquid concentrate composition of the invention.

Yet another class of excipient material that can be useful in compositions of the present invention is an oil, such as a triglyceride ester of fatty acids of animal, vegetable or synthetic origin, a paraffin, a polysiloxane, or a fatty acid or an ester or amide thereof. Such an oil, or mixture of oils, is present in an adjuvant amount as defined above. Examples of suitable oils include triglyceride esters of the coconut oil type, such as the product Miglyol™812 of Hüls, corn oil, olive oil, C₁₂₋₁₅ alkyl benzoate, eicosapentaenoic and docosahexaenoic acids and alkyl and triglyceride esters thereof and triglyceride ester of caprylic acid. Oils can be fractionated or not. Fractionation permits elimination of certain fatty acid chain lengths so as to modify melting point.

In a particular embodiment of the invention, one or more oil(s) are included, each having a chemical structure corresponding to formula (IX):

R¹⁴—CO—Y—R¹⁵ (IX)

wherein R¹⁴ is a hydrocarbyl group having about 5 to about 21 carbon atoms, R¹⁵ is a hydrocarbyl group having 1 to about 14 carbon atoms, the total number of carbon atoms in R¹⁴ and R¹⁵ is about 11 to about 27, and Y is O or NH. R¹⁴ and R¹⁵ are preferably linear hydrocarbyl chains. R14 preferably has about 11 to about 21 carbon atoms and is preferably derived from a natural saturated or unsaturated fatty acid. R¹⁵ is preferably an alkyl group with 1 to about 6 carbon atoms. Especially preferred oils of formula (IX) are therefore C₁₋₆ alkylesters or C₁₋₆ alkylamides of fatty acids. It is further preferred that R¹⁴ is saturated in about 40% to 100% by weight of all compounds of formula (IX) present in the composition.

In certain preferred embodiments, an oil is included that is a C₁₋₄ alkylester of a C₁₂₋₁₈ fatty acid, more preferably a C₁₋₄ alkylester of a C₁₂₋₁₈ saturated fatty acid. Examples include methyl oleate, ethyl oleate, isopropyl myristate, isopropyl palmitate and butyl stearate. Butyl stearate is especially preferred.

When present, one or more oil(s) of formula (IX) are preferably included in a ratio of total weight of such oil(s) to weight of the anionic exogenous chemical substance, expressed as acid equivalent, of about 1:100 to about 10: 1, preferably about 1:100 to about 1:1 and most preferably about 1:10 to about 1:3, though greater or lesser amounts can be found useful in particular situations.

Suitable concentrations of an oil of formula (IX) are about 0.001% to about 1% by weight in a plant treatment composition, and about 0.01% to about 10% by weight in a liquid concentrate composition of the invention.

Oil(s), if present, can be emulsified in a composition of the invention by means of the anionic compound(s) of formula (I) or amphiphilic salt(s) thereof. If desired, additional surfactant(s) can be included as emulsifier(s) for such oil(s). It is believed that the presence of oil, especially an oil of formula (IX), in the composition can further enhance penetration of the exogenous chemical substance into or through plant cuticles, perhaps as a result of the more lipophilic character imparted to the composition.

The effect of including a suitable oil in a composition of the invention is generally to enlarge supramolecular aggregates to form swollen micelles or emulsion particles. In such a composition, the mean size of supramolecular aggregates can be within the range defined above for compositions lacking oil, or larger, for example up to about 1000 nm.

A class of adjuvant compound that has been found to provide surprisingly enhanced biological effectiveness when included in a composition of the present invention is a compound comprising a polyoxyethylene chain having about 2 to about 100 ethylene oxide units. Such a compound can have more than one such polyoxyethylene chain. Such a compound can be a surfactant further comprising a hydrophobic moiety, but is not necessarily a surfactant. For example, polyethylene glycol having an average molecular weight of about 100 to about 4000 is such a compound. Many polyoxyethylene surfactants mentioned above also meet the requirements of such a compound. Illustrative examples are polyoxyethylene (15) tallowamine and polyoxyethylene (27) C₁₆₋₁₈ alcohol.

A polyoxyethylene compound as just described, if included, is preferably present in a plant treatment composition in a weight ratio to the exogenous chemical substance of about 1:10 to about 10:1, more preferably about 1:3 to about 3:1. Typically this corresponds to a concentration of about 0.005% to about 5%, more preferably about 0.05% to about 1% and most preferably about 0.1% to about 0.5% by weight. In a liquid concentrate composition, a polyoxyethylene compound, if included, is preferably present at a concentration of about 5% to about 20% by weight. Greater or lesser amounts can be found useful in particular situations.

In a particular embodiment of the present invention, therefore, a plant treatment composition for application to foliage of a plant to elicit a biological response is provided, comprising water, wherein are dissolved or dispersed an anionic exogenous chemical substance and one or more amine compound(s) each having the formula (I)

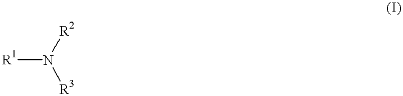

wherein R¹ is a hydrocarbyl group, preferably a linear hydrocarbyl chain, having 6 to about 22 carbon atoms, and R² and R³ are independently C₁₋₅ hydrocarbyl groups; wherein the exogenous chemical substance is present in the composition in an amount sufficient to elicit the biological response when the composition is applied to the foliage of the plant at a rate of about 10 to about 1000 liters per hectare (l/ha); wherein the amine compound(s) of formula (I) are present in the composition typically in a mole ratio to the exogenous chemical substance of about 0.01:1 to about 2:1; the composition further comprising an adjuvant compound having a molecular structure that comprises a polyoxyethylene chain having about 2 to about 100 ethylene oxide units, in a weight ratio to the exogenous chemical substance of about 1:10 to about 10:1, preferably about 1:3 to about 3:1.

Concentrate compositions

Although a plant treatment composition as described with respect to any of the above embodiments can be prepared on-site as a dilute aqueous solution or dispersion immediately before application to foliage of a plant, a preferred embodiment of the invention is a storage-stable concentrate composition. When dissolved or dispersed in, or diluted with, a suitable amount of water, a concentrate composition of the invention forms a plant treatment composition as described above. Thus the ratios of ingredients other than water defined for a plant treatment composition herein apply equally to a concentrate composition. Typically in preparing a plant treatment composition, one part by weight of a concentrate composition is added to about 9 to about 99 parts by weight of water; however greater or lesser amounts of water can be useful in particular situations.

Concentrate compositions of the invention can be solid or liquid. Formulation types known in the art to be generally suitable for foliar-applied anionic exogenous chemical substances are useful for the present invention. These include, without restriction, concentrated aqueous solutions and dispersions, emulsions (including oil-in-water, water-in-oil and water-in-oil-in-water types), microemulsions, suspension concentrates, emulsifiable concentrates, suspoemulsions, wettable powders, water-soluble powders and granules, water-dispersible powders and granules, etc.

A solid concentrate composition of the invention, such as a water-soluble or water-dispersible granule formulation, contains in total at least about 5% by weight and up to about 75% or more by weight of exogenous chemical substance expressed as acid equivalent. Preferably the content of exogenous chemical substance in a solid concentrate composition is about 25% to about 75%, more preferably about 50% to about 75%, a.e. by weight. Solid compositions are sometimes referred to as “dry” formulations; this should not be taken to imply that such compositions are entirely free of water or other liquid, merely that they feel dry to the touch.

A liquid concentrate composition of the invention, such as an aqueous solution or dispersion, contains in total at least about 5% by weight and up to about 50% or more by weight of exogenous chemical substance expressed as acid equivalent. Preferably the content of exogenous chemical substance in a solid concentrate composition is about 15% to about 45%, more preferably about 20% to about 45%, a.e. by weight.

Process for making a composition of the invention

Concentrate compositions in accordance with the present invention can be prepared by the following general procedures; however, the invention is not limited to compositions made by these procedures.

In a suitable process for making a liquid concentrate composition, the first step is a neutralizing step. This step comprises neutralization of a first molar amount X¹ of an anionic exogenous chemical substance with one or more amine compound(s) of formula (I) in a liquid medium, preferably an aqueous medium, with agitation to make a liquid composition containing one or more amphiphilic salt(s) of the exogenous chemical substance. In an example of the neutralizing step where the exogenous chemical substance is glyphosate, a first molar amount X¹ of glyphosate acid (GH₂) is added to water together with an amine compound of formula (I), in an amount of about 1 to about 2 moles per mole of glyphosate, to make a monobasic salt [GH⁻] [A⁺], a dibasic salt [G²⁻] [ A⁺]₂ or a mixture of such monobasic and dibasic salts, where A⁺is a cation derived by protonation of the amine compound. The relative molar proportions of monobasic and dibasic salts is a function of the quantity of the amine compound added per mole of glyphosate.

The neutralizing step can further comprise introducing to the liquid composition, with agitation, a second molar amount X² of the exogenous chemical substance in the form of one or more salt(s) other than the amphiphilic salt(s) formed from the first molar amount X¹. In an example where the exogenous chemical substance is glyphosate, a second molar amount X² of glyphosate is added in the form of a monobasic salt [GH⁻] [B⁺], a dibasic salt [G²⁻] [B⁺]₂, or a mixture of such monobasic and dibasic salts, where B⁺ is a cation derived from a base other than the amine compound(s) of formula (I) used to neutralize the first molar amount X¹ of glyphosate.

Optionally a third molar amount X³ of the exogenous chemical substance can be present during the neutralizing step, but is not neutralized, there being an insufficient amount of base(s) from which A⁺ and B⁺ cations are derived to neutralize all of the exogenous chemical substance present.

The salt(s) of the second molar amount of the exogenous chemical substance can be prepared separately in advance, or made in situ by neutralizing, in the liquid medium with agitation, this second molar amount with one or more base(s) other than the amine compound(s) used to neutralize the first molar amount. In either case, introduction of such salt(s) can occur before, during or after neutralization of the first molar amount of the exogenous chemical substance.

The neutralizing step takes place with agitation, preferably moderate agitation, for example using a magnetic stirrer. In a preferred embodiment, the neutralizing step is conducted at a temperature higher than the melting point of the amine compound(s) of formula (I) used. Typically the temperature of the liquid medium during the neutralizing step is about 50° C. to about 100° C.

In a suitable process, the second step is a conditioning step. This step comprises continuing the agitation of the liquid composition until supramolecular aggregates comprising amphiphilic salt(s) of the exogenous chemical substance formed by neutralizing the exogenous chemical substance with an amine compound of formula (I) are colloidally dispersed in the liquid medium. Agitation, preferably moderate agitation, can be provided, for example, by the same device used to agitate during the neutralizing step. It is preferred to maintain an elevated temperature, similar to that provided during the neutralizing step, throughout the conditioning step. The conditioning step can last for a period of a few minutes to a few hours and results in spontaneous formation of a stable colloidal dispersion of supramolecular aggregates, typically in the form of micelles and larger aggregates as described above.

Ingredients other than salt(s) of the exogenous chemical substance can be dissolved or dispersed in the liquid medium prior to, during or after the neutralization step and prior to, during or after the conditioning step. An optimum order of addition can readily be established for any composition by routine experimentation.

The product of the process just described is a liquid concentrate composition which, when diluted in water, provides a plant treatment composition of the first embodiment of the present invention.

An alternative process is illustrated with reference to glyphosate as the exogenous chemical substance. In a first step, a first concentrated aqueous solution is prepared comprising a salt of glyphosate with a low molecular weight cationic counterion. For example, the first concentrated aqueous solution can be prepared by neutralizing glyphosate acid in an aqueous medium with a suitable base such as sodium hydroxide, ammonia or isopropylamine. In a second step, a second concentrated aqueous solution or dispersion is prepared comprising an acid salt of an amine compound of formula (I). For example, the second concentrated aqueous solution or dispersion can be prepared by neutralizing the amine compound in an aqueous medium with a suitable acid such as hydrochloric acid, sulfuric acid or acetic acid. In a third step, the first concentrated aqueous solution and the second concentrated solution or dispersion are mixed to form a liquid concentrate composition of the invention.

The product of this alternative process is a liquid concentrate composition which, when diluted in water, provides a plant treatment composition of either the first or the second embodiment of the present invention, depending upon the results of testing of that composition as hereinbefore described.

A process for preparing a solid concentrate composition of the invention comprises a first step of mixing an anionic exogenous chemical substance, or a salt thereof, or a mixture of such anionic exogenous chemical substance and salt thereof, in solid particulate form with one or more amine compound(s) of formula (I), together with sufficient water to form a wet mix of consistency suitable for further process steps as described immediately below. Other ingredients can be included in this mixing step. The amine compound(s) of formula (I) and the exogenous chemical substance are mixed in relative amounts calculated to provide the desired mole ratio in the solid concentrate composition. At relatively low mole ratios, for example up to about 0.3: 1, the wet mix formed can be suitable for further processing without the presence of any solid inert carrier; but at higher mole ratios it will probably be found necessary to include a solid inert carrier in order to obtain a wet mix of the desired consistency. Suitable solid inert carriers are known to those of skill in the art; illustrative examples include finely divided particulate silica, inorganic salts such as ammonium sulfate, etc. Suitable amounts of ingredients in the mixing step can be established by one of skill in the art by routine experimentation.

Such a process further comprises a second step of granulating the wet mix to form moist coherent granules, and a third step of drying the granules. Any granulating method known in the art to be suitable for the preparation of water-soluble or water-dispersible granules of an exogenous chemical substance can be used; preferred methods are pan granulation and extrusion granulation. The extrusion process described in United Kingdom Patent Application No. 1 433 882 is one illustrative process that can be useful in preparing granular compositions of the present invention. Any drying method known in the art to be suitable for the preparation of water-soluble or water-dispersible granules of an exogenous chemical substance can be used; a preferred method is fluid-bed drying.

Application of a contemplated composition to foliage

Exogenous chemical substances are applied to plants at a rate sufficient to give the desired effect. These application rates are usually expressed as amount of exogenous chemical substance per unit area treated, e.g. grams per hectare (g/ha). What constitutes a “desired effect” varies according to the standards and practice of those who investigate, develop, market and use a specific class of exogenous chemical substances. For example, in the case of a herbicide, the amount applied per unit area to give, consistently and reliably, at least 85% control of a plant species as measured by growth reduction or mortality is often used to define a commercially effective rate.

Herbicidal effectiveness is one of the biological effects that can be enhanced through this invention. “Herbicidal effectiveness,” as used herein, refers to any observable measure of control of plant growth, which can include one or more of the actions of (1) killing, (2) inhibiting growth, reproduction or proliferation, and (3) removing, destroying, or otherwise diminishing the occurrence and activity of plants.

The selection of application rates that are biologically effective for a specific exogenous chemical substance is within the skill of the ordinary agricultural scientist. Those of skill in the art will likewise recognize that individual plant conditions, weather and growing conditions, as well as the specific exogenous chemical substance and composition thereof selected, will influence the degree of biological effectiveness achieved in practicing this invention. Useful application rates for exogenous chemical substances employed can depend upon all of the above conditions. With respect to the use of the method of this invention for glyphosate herbicide, much information is known about appropriate application rates. Over two decades of glyphosate use and published studies relating to such use have provided abundant information from which a weed control practitioner can select glyphosate application rates that are herbicidally effective on particular species at particular growth stages in particular environmental conditions.

Herbicidal compositions of glyphosate or derivatives thereof are used to control a very wide variety of plants worldwide. Glyphosate compositions of the invention can be applied to a plant in a herbicidally effective amount, and can effectively control one or more plant species of one or more of the following genera without restriction: Abutilon, Amaranthus, Artemisia, Asclepias, Avena, Axonopus, Borreria, Brachiaria, Brassica, Bromus, Chenopodium, Cirsium, Commelina, Convolvulus, Cynodon, Cyperus, Digitaria, Echinochloa, Eleusine, Elymus, Equisetum, Erodium, Helianthus, Imperata, Ipomoea, Kochia, Lolium, Malva, Oryza, Ottochloa, Panicum, Paspalum, Phalaris, Phragmites, Polygonum, Portulaca, Pteridium, Pueraria, Rubus, Salsola, Setaria, Sida, Sinapis, Sorghum, Triticum, Typha, Ulex, Xanthium and Zea.

Particularly important annual broadleaf species for which glyphosate compositions are used are exemplified without limitation by the following: velvetleaf (Abutilon theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), momingglory (Ipomoea spp.), kochia (Kochia scoparia), mallow (Malva spp.), wild buckwheat, smartweed, etc. (Polygonum spp.), purslane (Portulaca spp.), russian thistle (Salsola spp.), sida (Sida spp.), wild mustard (Sinapis arvensis) and cocklebur (Xanthium spp.)

Particularly important annual narrowleaf species for which glyphosate compositions are used are exemplified without limitation by the following: wild oat (Avenafatua), carpetgrass (Axonopus spp.), downy brome (Bromus tectorum), crabgrass (Digitaria spp.), bamyardgrass (Echinochloa crus-galli), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays).

Particularly important perennial broadleaf species for which glyphosate compositions are used are exemplified without limitation by the following: mugwort (Artemisia spp.), milkweed (Asclepias spp.), canada thistle (Cirsium arvense), field bindweed (Convolvulus arvensis) and kudzu (Pueraria spp.).

Particularly important perennial narrowleaf species for which glyphosate compositions are used are exemplified without limitation by the following: brachiaria (Brachiaria spp.), bermudagrass (Cynodon dactylon), yellow nutsedge (Cyperus esculentus), purple nutsedge (C. rotundus), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.).

Other particularly important perennial species for which glyphosate compositions are used are exemplified without limitation by the following: horsetail (Equisetum spp.), bracken (Pteridium aquilinum), blackberry (Rubus spp.) and gorse (Ulex europaeus).

Thus, glyphosate compositions of the present invention, and a process for treating plants with such compositions, can be useful on any of the above species. In a particular contemplated process, a plant treatment composition of the invention comprising glyphosate in the form of one or more salt(s) thereof is applied to foliage of crop plants genetically transformed to tolerate glyphosate, and simultaneously to foliage of weeds or undesired plants growing in close proximity to such crop plants. This process results in control of the weeds or undesired plants while leaving the crop plants substantially unharmed. Crop plants genetically transformed to tolerate glyphosate include those whose seeds are sold by Monsanto or under license from Monsanto bearing the Roundup Ready® trademark. These include varieties of cotton, soybean, canola and corn.

Application of plant treatment compositions to foliage of plants is preferably accomplished by spraying, using any conventional means for spraying liquids, such as spray nozzles or spinning-disk atomizers. Compositions of the present invention can be used in precision farming techniques, in which apparatus is employed to vary the amount of exogenous chemical substance applied to different parts of a field, depending on variables such as the particular plant species present, plant growth stage, soil moisture status, etc. In one embodiment of such techniques, a global positioning system operated with the spraying apparatus can be used to control application of the composition in desired amounts to different parts of a field.

A plant treatment composition is preferably dilute enough to be readily sprayed using standard agricultural spray equipment. Suitable application rates for the present invention vary depending upon a number of factors, including the type and concentration of active ingredient and the plant species involved. Useful rates for applying an aqueous composition to a field of foliage can range from about 25 to about 1,000 liters per hectare (l/ha), preferably about 50 to about 300 l/ha, by spray application.

A contemplated process for eliciting a desired biological activity in a plant or in a pathogen, parasite or feeding organism present in or on a plant further comprises, prior to the step of applying a plant treatment composition of the invention to foliage of the plant, a step of diluting, dissolving or dispersing, in a suitable volume of water, a concentrate composition as provided herein to form the plant treatment composition.

### EXAMPLES

The following Examples are provided for illustrative purposes only and are not intended to limit the scope of the present invention. The Examples will permit better understanding of the invention and perception of its advantages and certain variations of execution.

### Example 1

Glyphosate acid, in the form of a wet cake having a glyphosate assay of 86.5% a.e. by weight, is introduced in an amount of 1.2 g (equivalent to 6.1 mmol GH₂) to a 30 ml flask. N-cocoalkyl-N,N-dimethylamine (Noram™ DMC D of CECA S.A.) is then added in the amount of 1.3 g, calculated to be equivalent to 6.1 mmol (assuming a mean cocoalkyl chain length of 12 carbon atoms) to provide an amine to glyphosate a.e. mole ratio of 1:1. Next, 20 ml of deionized water (ion-exchanged and passed through a 0.2 μm filter) is added to provide an aqueous medium for neutralization of the glyphosate with the N-cocoalkyl-N,N-dimethylamine.

The flask is stoppered and placed in a water bath at 60° C. for 2 hours. Magnetic agitation is applied to ensure thorough mixing.

A stable colloidal dispersion is obtained which is of low viscosity and has a pH of about 4. The colloidal suspension is characterized by the following procedures.

Stability of the colloidal suspension is determined by observation. If no phase separation appears in the preparation flask upon storage for 48 hours without agitation, at ambient temperature, the colloidal suspension is considered stable for purposes of the present Example.

The CMC is determined by measuring surface tension at 25° C. over a range of concentrations by the plate method, otherwise known as the Wilhemy method, using a Kruss K12 automatic tensiometer. As the composition is diluted, surface tension initially is largely unaffected. After the CMC is reached, further dilution results in a progressive increase in surface tension, which eventually approaches that of pure water. If, on a graph, surface tension is plotted against concentration on a logarithmic scale, a curve is produced having a sharp break at a particular point below which surface tension is affected and above which surface tension is not or scarcely affected by concentration. The concentration at this break point corresponds to the CMC.

Size of supramolecular aggregates larger than simple micelles is measured by observation using transmission electron microscopy (TEM) with the negative staining technique. The colorant used is sodium silicotungstate, Na₄(Si(W₃O₁₀)₄).20H₂O. A transmission electron micrograph showing supramolecular aggregates larger than about 20 nm in the composition of Example 1 is presented in FIG. 1.

Results for Example 1 are presented in Table 1 below.

### Example 2

The procedure of Example 1 is followed, except that the amine compound used is Noram™DMSH D of CECA S.A., which is an alkyldimethylamine prepared from hydrogenated tallow and has as its main ingredient N-stearyl-N,N-dimethylamine. The weight of amine introduced is 1.812 g. Results for Example 2 are presented in Table 1 below.

### Example 3

The procedure of Example 1 is followed, except that a 50:50 molar ratio of N-cocoalkyl-N,N-dimethylamine (NoramTm DMC D) and N-stearyl-N,N-dimethylamine (NoramTm DMSH D) is used. The total weight of amine introduced is 1.55 g (0.65 g Noram™DMC D and 0.9 g Noram™DMSH D). Results for Example 3 are presented in Table 1 below.

### Example 4

The procedure of Example 1 is followed, except that the weight of N-cocoalkyl-N,N-dimethylamine introduced is 2.6 g, to provide a 2:1 mole ratio of amine to glyphosate. Results for Example 4 are presented in Table 1 below.

TABLE 1
Results for Examples 1-4

| | | | | | Surface |
|---|---|---|---|---|---|
| | Amine | Mole | Appear- | CMC | tension at |
| Example | compound¹ | ratio² | ance | (μM) | CMC (mN/m) |
| 1 | coco-N(Me)₂ | 1:1 | clear | 37 | 26.5 |
| 2 | C₁₈—N(Me)₂ | 1:1 | clear to | 31 | 30.7 |
| | | | turbid | | |
| 3 | coco-N (Me)₂ + | 1:1 | clear | not | not |
| | C₁₈—N(Me)₂ | | | deter- | determined |
| | | | | mined | |
| 4 | coco-N(Me)₂ | 2:1 | clear | 35 | 22.5 |

¹amine compound of formula (I); abbreviations for amine compounds can be understood by reference to the Examples.
²mole ratio of amine compound of formula (I) to glyphosate a.e.

### Example 5

Glyphosate acid, in the form of a wet cake having a glyphosate assay of 86.5% a.e. by weight, is introduced in an amount of 1.2 g (equivalent to 6.1 mmol GH₂) to a 30 ml flask. N-cocoalkyl-N,N-dimethylamine (Noram™DMC D of CECA S.A.) is then added in the amount of 0.65 g, calculated to provide an amine to glyphosate a.e. mole ratio of 0.5:1. Next, 20 ml of deionized water (ion-exchanged and passed through a 0.2 μm filter) is added to provide an aqueous medium for neutralization of the glyphosate with the N-cocoalkyl-N,N-dimethylamine.

The flask is stoppered and placed in a water bath at 60° C. for 2 hours. Magnetic agitation is applied to ensure thorough mixing. Then, with continuing agitation, trihexylamine is added in the amount of 0.822 g, calculated to provide, together with the N-cocoalkyl-N,N-dimethylamine, a total base to glyphosate a.e. mole ratio of 1:1. Agitation in the water bath is continued for a further 30 minutes.

A stable colloidal dispersion is obtained which is of low viscosity and has a pH of about 4.

### Example 6

The procedure of Example 5 is followed, except that in place of trihexylamine, a 1 M sodium hydroxide solution in the amount of 3.05 ml is added as the second base. A stable colloidal dispersion is obtained which is of low viscosity and has a pH of about 4.

### Example 7

N-cocoalkyl-N,N-dimethylamine (Noram™DMC D of CECA S.A.) in the amount of 2.52 g is introduced to a 30 ml flask together with a triglyceride fatty acid ester oil (Miglyol™817 of Hüls) in the amount of 0.888 g. The flask is stoppered and placed in a water bath at 60° C. with agitation until the N-cocoalkyl-N,N-dimethylamine dissolves in the oil. Then glyphosate acid, in the form of a wet cake having a glyphosate assay of 86.5% a.e. by weight, is added in an amount of 2.35 g (equivalent to 12 mmol GH₂). Next, 20 ml of deionized water (ion-exchanged and passed through a 0.2 μm filter) is added.

The flask is stoppered again and replaced in the water bath at 60° C. for 2 hours. Magnetic agitation is applied to ensure thorough mixing.

A stable, turbid emulsion is obtained which is of low viscosity and has a pH of about 4.

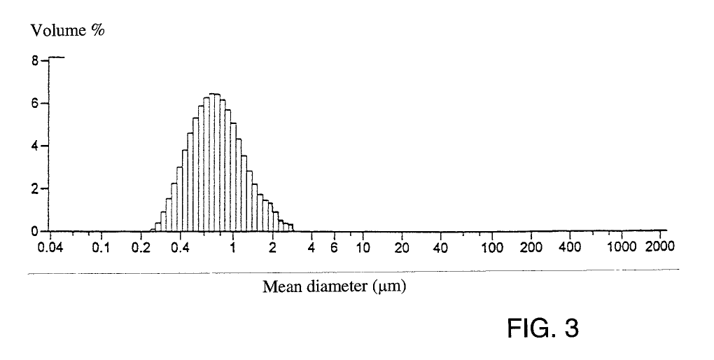

The particle size distribution of the emulsion composition of Example 7 is measured by light diffraction, using a Coulter LS230 apparatus. The diameter of the oil phase particles (swollen micelles) of the emulsion ranges from 300 to 3000 nm, as shown in FIG. 3, with a volume mean diameter of about 780 nm.

### Example 8

N-octyl-N,N-dimethylamine in the amount of 13.8 g, glyphosate acid (assay 96% by weight) in the amount of 12.0 g, and distilled water in the amount of 214 g are introduced to a 500 ml screw-topped vial. The mass fraction of glyphosate introduced is thus 50 grams per kilogram (g/kg). The mixture of ingredients is magnetically stirred at 50° C. for 5 hours to obtain a clear colloidal dispersion of supramolecular aggregates. The dispersion is cooled to room temperature. The pH of the formulation and the size of supramolecular aggregates (by dynamic light scattering) are measured after dilution of the dispersion with distilled water to a glyphosate concentration of 5 g a.e./kg. The 50 g a.e./kg suspension is examined for phase separation after standing without agitation at ambient temperature for 48 hours. Results for Example 8 are presented in Table 2 below.

### Example 9

The procedure of Example 8 is followed, except that the amine compound is N-cocoalkyl-N,N-dimethylamine (Noram™DMC D), added in the amount of 17.3 g, glyphosate acid is added in the amount of 12.0 g and distilled water is added in the amount of 211 g. Results for Example 9 are presented in Table 2 below.

### Example 10

The procedure of Example 8 is followed, except that the amine compound is N-tallowalkyl-N,N-dimethylamine (Noram™DMS D), added in the amount of 33.0 g, glyphosate acid is added in the amount of 12.0 g and distilled water is added in the amount of 195 g. Results for Example 10 are presented in Table 2 below.

TABLE 2
Results for Examples 8-10

| | | | | | | Average |
|---|---|---|---|---|---|---|
| | | | | | Phase | size of |
| | Amine | Mole | Appear- | | separ- | aggregates |
| Example | compound¹ | ratio² | rance | pH | ation | (nm) |
| 8 | C₈—N(Me)₂ | 1.29:1 | clear | 5.5 | no | not |
| | | | | | | deter- |
| | | | | | | mined |
| 9 | coco-N(Me)₂ | 1.19:1 | clear | 4.4 | no | 4.4 |
| 10 | tallow-N(Me)₂ | 1.64:1 | clear | 4.6 | no | 2.0 |

¹amine compound of formula (I); abbreviations for amine compounds can be understood by reference to the Examples.
²mole ratio of amine compound of formula (I) to glyphosate a.e.

### Example 11

The compositions of Example 8 (comprising N-octyl-N,N-dimethylammonium glyphosate) and Example 9 (comprising N-cocoalkyl-N,N-dimethylammonium glyphosate) are evaluated for herbicidal effectiveness in a greenhouse test by foliar application to a representative annual broadleaf species, velvetleaf (Abutilon theophrasti, ABUTH) and a representative annual narrowleaf species, Japanese millet, a form of barnyardgrass (Echinochloa crus-galli, ECHCF). For comparative purposes, the following commercial standard formulations are included in the test:

MON 0139, an aqueous solution of the mono(isopropylammonium) salt of glyphosate, containing 62% by weight of said salt and no other formulation ingredients except water, available from Monsanto Company; and

Roundup® Ultra herbicide, an aqueous solution concentrate formulation of the mono(isopropylammonium) salt of glyphosate, containing 41% by weight of said salt together with a surfactant, this product being sold as an agricultural herbicide by Monsanto Company in the U.S.A.

MON 0139 contains glyphosate at a concentration of about 680 grams of acid equivalent per liter (g a.e./l) and Roundup® Ultra herbicide contains 356 g a.e./l.

The following procedure is used for the greenhouse test.

Seeds of the plant species indicated are planted in 85 mm square pots in a soil mix which has previously been steam sterilized and prefertilized with a 14-14-14 NPK slow release fertilizer at a rate of 3.6 kg/m³. The pots are placed in a greenhouse with sub-irrigation. About one week after emergence, seedlings are thinned as needed, including removal of any unhealthy or abnormal plants, to create a uniform series of test pots.

The plants are maintained for the duration of the test in the greenhouse where they receive a minimum of 14 hours of light per day. If natural light is insufficient to achieve the daily requirement, artificial light with an intensity of approximately 475 microeinsteins is used to make up the difference. Exposure temperatures are not precisely controlled but average about 27° C. during the day and about 18° C. during the night. Plants are sub-irrigated throughout the test to ensure adequate soil moisture levels. Relative humidity is maintained at about 50% for the duration of the test.

Pots are assigned to different treatments in a fully randomized experimental design with 3 replications. A set of pots is left untreated as a reference against which effects of the treatments can later be evaluated. Two sets of 3 replications are provided for treatments with Roundup® Ultra, to ensure a sound basis is available for comparison of herbicidal effectiveness of compositions of the invention.

Application of glyphosate compositions to foliage is made by spraying with a track sprayer fitted with a TeeJetTM 9501E nozzle calibrated to deliver a spray volume of 93 liters per hectare (l/ha) at a pressure of 166 kilopascals (kPa). Application is made when the plants are 2-3 weeks old. After treatment, pots are returned to the greenhouse until ready for evaluation, in this Example 15 days after treatment (DAT).

Treatments are made using dilute aqueous compositions, prepared by dilution with water of preformulated concentrate compositions. All comparisons are made at equal glyphosate acid equivalent rates. The required degree of dilution for a glyphosate concentrate composition to make a plant treatment composition is calculated from the equation

A=RS/VC

where A is the volume in milliliters (ml) of the glyphosate composition to be added to the plant treatment composition being prepared, R is the desired glyphosate rate in grams of acid equivalent per hectare (g a.e./ha), S is the total volume in milliliters (ml) of plant treatment composition being prepared, V is the application rate in liters per hectare (l/ha) of plant treatment comosition, conventionally referred to as “spray volme”, and C is the concentration of glyphosate in grams of acid equivalent per liter (g a.e./l) in the glyphasate composition.

For evaluation of herbicidal effectiveness, all plants in the test are examined by a single practiced technician, who records percent inhibition, a visual measurement of the effectiveness of each treatment by comparison with untreated plants. Inhibition of 0% indicates no effect, and inhibition of 100% indicates that all of the plants are completely dead. Inhibition of 85% or more is in most cases considered acceptable for normal herbicidal use; howeverin greenhouse tests such as the one described in this Example itis normal to apply compositons at rates which are expected to give less than 85% inhibition, as this makes it easier to discriminate among compositions having different levels of effectiveness.

Results of the test of Example 11 are given in Table 3 below.

TABLE 3
Herbicidal effectiveness data for Example 11

| | Glyphosate rate | % Inhibition | |
|---|---|---|---|
| Glyphosate composition | g a.e./ha | ABUTH | ECHCF |
| MON 0139 | 200 | 0 | 50 |
| | 400 | 2 | 62 |
| | 600 | 43 | 75 |
| | 800 | 72 | 77 |
| | 1000 | 83 | 85 |
| Roundup ® Ultra (first set) | 200 | 20 | 50 |
| | 400 | 57 | 60 |
| | 600 | 75 | 82 |
| | 800 | 88 | 93 |
| | 1000 | 95 | 94 |
| Roundup ® Ultra (second set) | 200 | 5 | 67 |
| | 400 | 33 | 73 |
| | 600 | 72 | 83 |
| | 800 | 87 | 85 |
| | 1000 | 90 | 96 |
| Composition of Example 8 | 200 | 2 | 37 |
| | 400 | 27 | 50 |
| | 600 | 60 | 53 |
| | 800 | 88 | 70 |
| | 1000 | 85 | 80 |
| Composition of Example 9 | 200 | 3 | 37 |
| | 400 | 67 | 50 |
| | 600 | 77 | 62 |
| | 800 | 83 | 67 |
| | 1000 | 88 | 73 |

In this test the colloidal dispersions of N-octyl-N,N-dimethylammonium glyphosate (Example 8) and N-cocoalkyl-N,N-dimethylammonium glyphosate (Example 9) provided herbicidal effectiveness on ABUTH superior to that provided by isopropylammonium glyphosate (MON 0139) at equal glyphosate a.e. rates. However, herbicidal effectiveness of these colloidal dispersions was not as great as that provided by the commercial standard Roundup® Ultra in this test.

### Example 12

Substantially the same procedure as used in Example 11 is followed, except where noted below, in a greenhouse test by foliar application to two representative annual broadleaf species, wild radish (Raphanus sativus, RAPSN) and tall momingglory (Ipomoea purpurea, PHBPU), and a representative perennial narrowleaf species, quackgrass (Elymus repens, AGRRE). Soil is prefertilized with a 6-7-8 organic NPK fertilizer at a rate of 3.9 kg/m³. Plants receive 16 hours of light per day. Temperatures are maintained at approximately 23° C. during the day and approximately 18° C. during the night. Relative humidity is maintained at approximately 70%. Only one set of 3 replicates is assigned to Roundup® Ultra in this test. An early evaluation of herbicidal effectiveness is conducted 5 DAT, as an indication of enhanced early symptom development, as well as a later evaluation conducted 22 DAT. The compositions included in this test are those of Examples 8 (comprising N-octyl-N,N-dimethylammonium glyphosate) and 9 (comprising N-cocoalkyl-N,N-dimethylammonium glyphosate). Results of the test of Example 12 are given in Table 4 below.

TABLE 4
Herbicidal effectiveness data for Example 12

| | Gly- | | | | | |
|---|---|---|---|---|---|---|
| | phosate | % Inhibition | | | | |
| Glyphosate | rate | 5 DAT | | 22 DAT | | |
| composition | g a.e./ha | RAPSN | PHBPU | AGRRE | RAPSN | PHBPU |
| MON 0139 | 360 | 10 | 18 | 43 | 28 | 30 |
| | 540 | 10 | 15 | 55 | 35 | 32 |
| | 720 | 10 | 17 | 47 | 40 | 32 |
| Roundup ® | 360 | 17 | 20 | 67 | 47 | 73 |
| Ultra | 540 | 30 | 23 | 67 | 63 | 80 |
| | 720 | 23 | 38 | 75 | 88 | 95 |
| Composition | 360 | 20 | 15 | 55 | 43 | 23 |
| of | 540 | 27 | 17 | 78 | 53 | 32 |
| Example 8 | 720 | 15 | 15 | 72 | 67 | 37 |
| Composition | 360 | 33 | 35 | 65 | 73 | 63 |
| of | 540 | no data | no data | no data | no data | no data |
| Example 9 | 720 | 62 | 55 | 88 | 87 | 92 |

In this test the colloidal dispersion of N-octyl-N,N-dimethylammonium glyphosate (Example 8) provided herbicidal effectiveness on AGRRE similar to that provided by the commercial standard Roundup® Ultra at equal glyphosate a.e. rates. The clloidal dispersion of N-cocoalkyl-N,N-dimethylammonium glyphosate (Example 9) was in general more effective on all three species than the composition of Exaple 8. Early smptom divelopment (5 DAT) was more pronounced with the composition of Example 9 than with Roundup® Ultra.

### Example 13

Substantially the same procedure as used in Example 11 is followed in a greenhouse test by foliar application to ABUTH and ECHCF. Evaluation of herbicidal effectiveness is conducted 21 DAT. The compositions included in this test are those of Exaples 9 (comprising N-cocoalkyl-N,N-dimethylammonium glyphosate) and 10 (comprising N-tallowalkyl-N,N-dimethylammonium glyphosate). Results of the test of Example 3 are given in Table 5 below.

TABLE 5
Herbicidal effectiveness data for Example 13

| | Glyphosate rate | % Inhibition | |
|---|---|---|---|
| Glyphosate composition | g.a.e./ha | ABUTH | ECHCF |
| MON 0139 | 200 | 0 | 50 |
| | 400 | 20 | 77 |
| | 600 | 45 | 87 |
| | 800 | 47 | 88 |
| | 1000 | 73 | 95 |
| Roundup ® Ultra (first set) | 200 | 25 | 77 |
| | 400 | 50 | 95 |
| | 600 | 63 | 98 |
| | 800 | 92 | 100 |
| | 1000 | 100 | 100 |
| Roundup ® Ultra (second set) | 200 | 10 | 80 |
| | 400 | 40 | 97 |
| | 600 | 60 | 99 |
| | 800 | 90 | 100 |
| | 1000 | 98 | 100 |
| Composition of Example 9 | 200 | 5 | 82 |
| | 400 | 50 | 94 |
| | 600 | 75 | 97 |
| | 800 | 77 | 99 |
| | 1000 | 87 | 100 |
| Composition of Example 10 | 200 | 33 | 82 |
| | 400 | 75 | 83 |
| | 600 | 78 | 87 |
| | 800 | 83 | 90 |
| | 1000 | 83 | 85 |

In this test the collodial dispersions of N-cocoalkyl-N,N-dimethylammonium glyphosate (Example 9) and N-tallowalkyl-N,N-dimethylammonium glyphosate (Example 10) provided herbicidal effectiveness on ABUTH that was comparable to that provided by Roundup® Ultra at equal glyphosate a.e. rates.

### Example 14

The procedure of Example 8 is followed to make a comparative composition whrein the amine comound is laurylamine (Noram™ 12D). Laurylamine is added in the amount of 9.4 g, glyphosate acid is added in the amount of 12.0 g and distilled water is added in the amount of 206 g. Isopropanol in the amount of 12 g is added immediately prior to the distilled water. The composition, at a mole ratio of laurylamine to glyphosate a.e. of 0.72:1, has a pH of 4.5. It is turbid in appearance but does not show phase separation. Averge size of aggregates is determined to be 2.0 nm.

To compare the herbicidal effectiveness of a composition of the invention (that of Exmaple 10, comprising N-tallowalkyl-N,N-dimethylammonium glyphosate) with this comparative composition, substantially the same procedure as used in Example 12 is followed in a greenhouse test by foliar application to RAPSN, PHBPU and AGRRE. Only one set of 3 replicates is assigned to Roundup® Ultra in this test. Evaluation of herbicidal effectiveness is conducted 22 DAT. Results of the test of Example 14 are given in Tale 6 below.

TABLE 6
Herbicidal effectiveness data for Example 14

| | Glyphosate rate | % Inhibition | | |
|---|---|---|---|---|
| Glyphosate composition | g a.e./ha | AGRRE | RAPSN | PHBPU |
| MON 0139 | 360 | 53 | 48 | 43 |
| | 540 | 57 | 57 | 47 |
| | 720 | 65 | 78 | 57 |
| Roundup ® Ultra | 360 | 78 | 58 | 58 |
| | 540 | 88 | 95 | 58 |
| | 720 | 97 | 83 | 65 |
| Composition of | 360 | 97 | 77 | 80 |
| Example 10 | 540 | 99 | 75 | 83 |
| | 720 | 99 | 82 | 93 |
| Comparative composition | 360 | 55 | 53 | 53 |
| (laurylammonium salt) | 540 | 70 | 53 | 52 |
| | 720 | 80 | 55 | 57 |

The colloidal disperson of N-tallowalkyl-N,N-dimethylammonium glyphosate (Exmaple 10) outperformed Roundup® Ultra at least on AGRRE and PHBPU. By contrast, the comparative compsotion comprising N-laurylammonium glyphosate had much weaker herbicidal efficacy, performing no better than MON 0139 on RAPSN and PHBPU and only slightly better than MON 0139 on AGRRE.

### Example 15

A series of coositons, each having a 1:1 mole ratio of all bases to glyphosate a.e. are prepared as follows. First, two compositions are prepared by the general procedure of Example 1, composition 15-5 using N-decyl-N,N-dimethylamine and compositon 15-10 using N-cocoalkyl-N,N-dimethylamine (Noram™ DMC D). Both are prepared ata 1:1 mole ratio of the respective amine compound to glyphosate a.e. Next, mixtures are prepared of each of these compositions with glyphosate isopropylamine salt (added in the form of MON 0139, wherein the mole ratio of isopropylamine to glyphosate a.e. is approximately 1: 1), so as to provide a range of aqueous compositions having a mole ratio of N-decyl-N,N-dimethylamine or N-cocoalkyl-N,N-dimethylamine to glyphosate a.e. lower than 1:1. All compositions are prepared at a glyphosate loading of 10% a.e. by weight. The compositions prepared are:

| | | | |
|---|---|---|---|
| 15-1 | N-decyl-N,N-dimethylamine | mole ratio | 0.02:1 |
| 15-2 | N-decyl-N,N-dimethylamine | mole ratio | 0.1:1 |
| 15-3 | N-decyl-N,N-dimethylamine | mole ratio | 0.25:1 |
| 15-4 | N-decyl-N,N-dimethylamine | mole ratio | 0.5:1 |
| 15-5 | N-decyl-N,N-dimethylamine | mole ratio | 1:1 |
| 15-6 | N-cocoalkyl-N,N-dimethylamine | mole ratio | 0.02:1 |
| 15-7 | N-cocoalkyl-N,N-dimethylamine | mole ratio | 0.1:1 |
| 15-8 | N-cocoalkyl-N,N-dimethylamine | mole ratio | 0.25:1 |
| 15-9 | N-cocoalkyl-N,N-dimethylamine | mole ratio | 0.5:1 |
| 15-10 | N-cocoalkyl-N,N-dimethylamine | mole ratio | 1:1 |

Note the athe mole ratios given above for compositions 15-6 to 15-10 include amine compounds having the full range of alkyl chain lengths derived from coconut oil. If only amine compounds of C₁₄ or greater chain length are to be considered, the corresponding mole ratio can be estimated by multiplying the above mole ratios by 0.3. For example, for composition 15-7 the mole ratio of amine compounds having C₁₄ or greater chain length to glyphosate a.e. is approximately 0.03:1.

Finally, a “blank” composition corresponding to the composition of Example 9 is prepared, in which N-cocoalkyl-N,N-dimethylamine is neutralized with hydrochloric acid instead of glyphosate, to form an aqueous solution or dispersion of N-cocoalkyl-N,N-dimethylammonium chloride.

Substantially the same procedure as used in Example 11 is followed in a greenhouse test by foliar application to ABUTH and ECHCF. Evaluation of herbicidal effectiveness is conducted 16 DAT. The composition of Example 9 is included in this test, as is a composition prepared immediately before application by mixing the “blank” of Example 9 as described immediately above with MON 0139 to provide a mole ratio of N-cocoalkyl-N.N-dimethylamine to glyphosate a.e. of 1.19:1, the same mole rtio as found in the copositioin of Example 9. Also included in this test are compostions 15-1 to 15-10 as listed above. Results of the test of Example 15 are given in Table 7 below.

TABLE 7
Herbicidal effectiveness data for Example 15

| | Glyphosate rate | % Inhibition | |
|---|---|---|---|
| Glyphosate composition | g a.e./ha | ABUTH | ECHCF |
| MON 0139 | 50 | 0 | 2 |
| | 100 | 5 | 30 |
| | 200 | 72 | 53 |
| | 400 | 82 | 70 |
| | 600 | 87 | 77 |
| Roundup ® Ultra (first set) | 50 | 0 | 52 |
| | 100 | 67 | 80 |
| | 200 | 85 | 98 |
| | 400 | 95 | 100 |
| | 600 | 100 | 100 |
| Roundup ® Ultra (second set) | 50 | 0 | 55 |
| | 100 | 60 | 78 |
| | 200 | 83 | 99 |
| | 400 | 97 | 100 |
| | 600 | 100 | 100 |
| Composition of Example 9 | 50 | 0 | 60 |
| coco-N(Me)₂, 1.19:1 mole ratio | 100 | 58 | 83 |
| | 200 | 80 | 98 |
| | 400 | 90 | 100 |
| | 600 | 99 | 100 |
| “Blank” of Example 9 + | 50 | 0 | 65 |
| MON 0139 | 100 | 57 | 82 |
| coco-N(Me)₂, 1.19:1 mole ratio | 200 | 83 | 99 |
| | 400 | 92 | 100 |
| | 600 | 99 | 100 |
| 15-1 | 50 | 0 | 5 |
| C₁₀—N(Me)₂, 0.02:1 mole ratio | 100 | 18 | 33 |
| | 200 | 72 | 58 |
| | 400 | 85 | 77 |
| | 600 | 92 | 83 |
| 15-2 | 50 | 0 | 0 |
| C₁₀—N(Me)₂, 0.1:1 mole ratio | 100 | 25 | 38 |
| | 200 | 73 | 58 |
| | 400 | 90 | 83 |
| | 600 | 95 | 83 |
| 15-3 | 50 | 0 | 5 |
| C₁₀—N(Me)₂, 0.25:1 mole ratio | 100 | 20 | 37 |
| | 200 | 73 | 60 |
| | 400 | 87 | 83 |
| | 600 | 92 | 98 |
| 15-4 | 50 | 0 | 8 |
| C₁₀—N(Me)₂, 0.5:1 mole ratio | 100 | 27 | 27 |
| | 200 | 75 | 65 |
| | 400 | 88 | 90 |
| | 600 | 97 | 99 |
| 15-5 | 50 | 0 | 13 |
| C₁₀—N(Me)₂, 1:1 mole ratio | 100 | 30 | 23 |
| | 200 | 75 | 55 |
| | 400 | 87 | 88 |
| | 600 | 97 | 100 |
| 15-6 | 50 | 0 | 20 |
| coco-N(Me)₂, 0.02:1 mole ratio | 100 | 15 | 57 |
| | 200 | 70 | 80 |
| | 400 | 82 | 100 |
| | 600 | 98 | 100 |
| 15-7 | 50 | 0 | 40 |
| coco-N(Me)₂, 0.1:1 mole ratio | 100 | 25 | 72 |
| | 200 | 68 | 99 |
| | 400 | 92 | 100 |
| | 600 | 99 | 100 |
| 15-8 | 50 | 0 | 62 |
| coco-N(Me)₂, 0.25:1 mole ratio | 100 | 27 | 77 |
| | 200 | 80 | 99 |
| | 400 | 92 | 100 |
| | 600 | 97 | 100 |
| 15-9 | 50 | 0 | 50 |
| coco-N(Me)₂, 0.5:1 mole ratio | 100 | 40 | 73 |
| | 200 | 82 | 99 |
| | 400 | 90 | 100 |
| | 600 | 96 | 100 |
| 15-10 | 50 | 0 | 52 |
| coco-N(Me)₂, 1:1 mole ratio | 100 | 43 | 70 |
| | 200 | 80 | 97 |
| | 400 | 87 | 100 |
| | 600 | 99 | 100 |

In this test the colloidal dispersion of N-cocoaklyl-N,N-dimethylammonium glyphosate (Example 9) provided herbicidal effectiveness on ABUTH and ECHCF at least equal to that provided by the commercial standard Roundup® Ultra. The composition formed by simply mixing N-cocoalkyl-N,N-dimethylammonium chloride and isopropylammonium glyphosate (“blank” of Example 9+MON 0139) was at least as herbicidally effective as the composition of Example 9 itself.

Overall, the compositions prepared with N-decyl-N,N-dimethylammonium glyphosate (15-1 to 15-5) exhibited a lower degree of herbicidal effectiveness than those prepared with N-cocoalkyl-N,N-dimethylammonium glyphosate (15-6 to 15-10). However, at a 0.02:1 mole ratio (15-6), N-cocoalkyl-N,N-dimethylammonium glyphosate was scarcely more effective than MON 0139. At mole ratios of 0.1:1 and higher (15-7 to 15-10), N-cocoalkyl-N,N-dimethylammonium glyphosate exhibited herbicidal effectiveness approaching or equalling that of the commercial standard Roundup® Ultra. Surprisingly, the highest mole ratio did not exhibit the greatest herbicidal effectiveness; overall the best performance in this series was seen with a 0.25:1 mole ratio (15-8).

### Example 16

A composition is prepared by the general procedure of Example 1, using N-octadecyl-N,N-dimethylamine (ADMA-18 of Albemarle) as the amine compound for neutralizing glyphosate. The mole ratio of N-octadecyl-N,N-dimethylamine to glyphosate is calculated to be 1.37:1. Upon dilution with water to a glyphosate a.e. concentration of 0.5% by weight, the composition is found by dynamic light scattering to contain spherical micelles having an average diameter of 5 nm and by static light scattering to have an average weight of 85,000 daltons. An average micelle is calculated to contain about 200 molecules of N-octadecyl-N,N-dimethylamine in total of protonated and non-protonated form, and about 150 molecules of glyphosate.

### Example 17

A series of compositions are prepared by the general procedure of Example 1, using the following amine compounds at the indicated amine/glyphosate a.e. mole ratios:

| | |
|---|---|
| N-cocoalkyl-N,N-dimethylamine (coco-NMe₂) | mole ratio 1.19:1 |
| N-tallowalkyl-N,N-dimethylamine (tallow-NMe₂) | mole ratio 1.56:1 |
| N-decyl-N,N-dimethylamine (C₁₀—NMe₂) | mole ratio 1.10:1 |
| N-dodecyl-N,N-dimethylamine (C₁₂—NMe₂) | mole ratio 1.23:1 |
| N-tetradecyl-N,N-dimethylamine (C₁₄—NMe₂) | mole ratio 1.08:1 |
| N-hexadecyl-N,N-dimethylamine (C₁₆—NMe₂) | mole ratio 1.28:1 |
| N-octadecyl-N,N-dimethylamine (C₁₈—NMe₂) | mole ratio 1.37:1 |
| N-oleyl-N,N-dimethylamine (C₁₈═NMe₂) | mole ratio 1.12:1 |

Substantially the same procedure as used in Example 11 is followed in a greenhouse test by foliar application to ABUTH and ECHCF, except that only one set of Roundup ® Ultra treatments is included. Evaluation of herbicidal effectiveness is conducted 15 DAT. Results of the test of Example 17 are given in Table 8 below.

TABLE 8
Herbicidal effectiveness data for Example 17

| | Glyphosate rate | % Inhibition | |
|---|---|---|---|
| Glyphosate composition | g a.e./ha | ABUTH | ECHCF |
| MON 0139 | 50 | 0 | 0 |
| | 100 | 0 | 5 |
| | 200 | 73 | 25 |
| | 400 | 90 | 55 |
| | 600 | 93 | 68 |
| Roundup ® Ultra | 50 | 2 | 3 |
| | 100 | 70 | 62 |
| | 200 | 90 | 91 |
| | 400 | 99 | 100 |
| | 600 | 100 | 99 |
| coco-N(Me)₂ | 50 | 5 | 15 |
| | 100 | 60 | 52 |
| | 200 | 87 | 87 |
| | 400 | 99 | 99 |
| | 600 | 100 | 100 |
| tallow-N(Me)₂ | 50 | 30 | 53 |
| | 100 | 80 | 80 |
| | 200 | 93 | 98 |
| | 400 | 99 | 98 |
| | 600 | 98 | 99 |
| C₁₀—NMe₂ | 50 | 0 | 3 |
| | 100 | 2 | 13 |
| | 200 | 77 | 63 |
| | 400 | 93 | 92 |
| | 600 | 98 | 99 |
| C₁₂—NMe₂ | 50 | 0 | 3 |
| | 100 | 20 | 48 |
| | 200 | 80 | 80 |
| | 400 | 97 | 100 |
| | 600 | 96 | 98 |
| C₁₄-NMe₂ | 50 | 2 | 10 |
| | 100 | 45 | 67 |
| | 200 | 85 | 90 |
| | 400 | 99 | 98 |
| | 600 | 99 | 96 |
| C₁₆NMe₂ | 50 | 0 | 48 |
| | 100 | 43 | 65 |
| | 200 | 88 | 85 |
| | 400 | 99 | 98 |
| | 600 | 99 | 93 |
| C₁₈—NMe₂ | 50 | 0 | 50 |
| | 100 | 50 | 70 |
| | 200 | 87 | 93 |
| | 400 | 98 | 96 |
| | 600 | 99 | 97 |
| C₁₈═NMe₂ | 50 | 0 | 53 |
| | 100 | 70 | 73 |
| | 200 | 92 | 97 |
| | 400 | 95 | 96 |
| | 600 | 100 | 92 |

In this test the colloidal dispersion of N-cocoalkyl-N,N-dimethylammonium glyphosate (coco-NMe₂) provided herbicidal effectiveness on ABUTH and ECHCF similar to that provided by the commerrcial standard Roundup® Ultra. The colloidal dispersion of N-tallowalkyl-N,N-dimethylammonium glyphosate (tallow-Nme₂) povided greater herbicidal effectiveness than Roundup® Ultra.

The N-dodecyl-N,N-dimethylammonium glyphosate (C₁₂-NMe₂) composition did not provide herbicidal effecitveness at as high a level as Roundup® Ultra or the N-cocoalkyl-N,N-dimethlammonium glyphosate (coco-NMe₂) composition, and the N-decyl-N,N-dimethylammonium glyphosate (C₁₀-Me₂) composition was even less efficacious. It is believed that the C₁₄ and longer alkyl chains present in the coco-NMe₂ composition are responsible for the high level of herbicidal activity seen with this compostion. Evidence for this is seen in the strong herbicidal effectiveness exhibited by compositions of N-tetradecyl-N,N-dimethylammonium (C₁₄-NMe₂), N-hexadecyl-N,N-dimethylammonium (C₁₆-NMe₂), N-octadecyl-N,N-dimethylammonium (C₁₈-NMe₂), N-oleyl-N,N-dimethylammonium C₁₈=NMe₂) and N-tallowalkyl-N,N-dimethylammonium (tallow-NMe₂) salts of glyphosate in this test.

### Example 18

A series of copositons ar preared by the general procedure of Example 1, using N-octadecyl-N,N-dimethylamine (C₁₈-NMe₂) as the amine compound at an amine compound/glyphasate a.e. mole ratio of 1.37:1. To each composition is added one of the following ajduvant comounds during processing: soya propl ester (primarily propyl oleate); methyl oleate; olive oil; tributyl phosphate; heptane; dimethylsulfoxide (DMSO); toluene; glycerol; corn syrup; gelatin; polyethylene glycol, average molecular weight 400 (PEG-400); polyethylene glycol, average molcular weight 3400 (PEG-3400). The weight of adjuvant compound added in each case is equal to the weight of glyphosate a.e. present. A composition is also prepared with N-octadecyl-N,N-dimethylamine butwith no such adjuvant compound.

Substantially the ame procedure as used in Example 11 is followed in a greenhouse test by foliar application to ABUTH and ECHCF, except that only one set of Roundup® Ultra treatments is included. Evaluation of herbicidal effectiveness is conducted 14 DAT. Results of the test of Example 18 are given in Table 9 below.

TABLE 9
Herbicidal effectiveness data for Example 18

| | Glyphosate rate | % Inhibition | |
|---|---|---|---|
| Glyphosate composition | g a.e./ha | ABUTH | ECHCF |
| MON 0139 | 50 | 0 | 0 |
| | 100 | 3 | 30 |
| | 200 | 70 | 45 |
| | 400 | 80 | 63 |
| | 600 | 94 | 68 |
| Roundup ® Ultra | 50 | 25 | 25 |
| | 100 | 77 | 55 |
| | 200 | 92 | 80 |
| | 400 | 98 | 99 |
| | 600 | 100 | 97 |
| C₁₈—NMe₂ | 50 | 0 | 40 |
| | 100 | 25 | 68 |
| | 200 | 82 | 90 |
| | 400 | 97 | 96 |
| | 600 | 98 | 100 |
| C₁₈—NMe₂ + propyl oleate | 50 | 0 | 50 |
| | 100 | 20 | 72 |
| | 200 | 83 | 95 |
| | 400 | 99 | 93 |
| | 600 | 99 | 97 |
| C₁₈—NMe₂ + methyl oleate | 50 | 0 | 50 |
| | 100 | 3 | 68 |
| | 200 | 80 | 80 |
| | 400 | 98 | 93 |
| | 600 | 99 | 96 |
| C₁₈—NMe₂ + olive oil | 50 | 0 | 50 |
| | 100 | 27 | 73 |
| | 200 | 83 | 90 |
| | 400 | 99 | 95 |
| | 600 | 100 | 94 |
| C₁₈—NMe₂ + tributyl phosphate | 50 | 0 | 17 |
| | 100 | 0 | 65 |
| | 200 | 77 | 83 |
| | 400 | 96 | 93 |
| | 600 | 98 | 99 |
| C₁₈—NMe₂ + heptane | 50 | 0 | 2 |
| | 100 | 5 | 62 |
| | 200 | 80 | 87 |
| | 400 | 97 | 99 |
| | 600 | 98 | 97 |
| C₁₈—NMe₂ + DMSO | 50 | 0 | 43 |
| | 100 | 27 | 70 |
| | 200 | 83 | 87 |
| | 400 | 96 | 96 |
| | 600 | 99 | 100 |
| C₁₈—NMe₂ + toluene | 50 | 0 | 10 |
| | 100 | 13 | 63 |
| | 200 | 80 | 96 |
| | 400 | 97 | 93 |
| | 600 | 99 | 99 |
| C₁₈—NMe₂ + glycerol | 50 | 0 | 0 |
| | 100 | 12 | 55 |
| | 200 | 78 | 83 |
| | 400 | 96 | 97 |
| | 600 | 99 | 97 |
| C₁₈—NMe₂ + corn syrup | 50 | 0 | 8 |
| | 100 | 47 | 53 |
| | 200 | 80 | 82 |
| | 400 | 93 | 90 |
| | 600 | 99 | 99 |
| C₁₈—NMe₂ + gelatin | 50 | 0 | 8 |
| | 100 | 18 | 60 |
| | 200 | 80 | 78 |
| | 400 | 88 | 90 |
| | 600 | 96 | 93 |
| C₁₈—NMe₂ + PEG-400 | 50 | 0 | 45 |
| | 100 | 77 | 75 |
| | 200 | 94 | 85 |
| | 400 | 98 | 99 |
| | 600 | 99 | 99 |
| C₁₈—NMe₂ + PEG-3400 | 50 | 0 | 50 |
| | 100 | 72 | 72 |
| | 200 | 83 | 88 |
| | 400 | 96 | 96 |
| | 600 | 99 | 100 |

In this test herbicidal effectiveness of a colloidal dispersion of N-octadecyl-N,N-dimethylammonium glyphosate was enchanced, especially on ABUTH, by inclusion of polyethylene glycol in te composition. Both PEG-400 and PEG-3400 had this effect.

### Example 19

Substantially the same procedure as used in Example 11 is followed in a greenhouse test by foliar aplicaton to ABUTH and ECHCF. In this test, the compositon of Example 9 is applied alone or in tank-mix with various surfactants, each at 0.25% and 1% by volume of the spray compositon. The surfactants tested are:

MON 0818 (Monsanto Company): based on polyoxyethylene (15) tallowamine;

Pluraac™A-38 (BASF): polyoxyethylene (27) C₁₆₋₁₈ alkylether;

Fluorade™FC-754 (3M): a cationic fluoroorganic surfactant believed to have the structure C₈F₁₇SO₂NH(CH₂)₃N⁺(CH₃)₃Cl⁻;

Argrimul™PG-2069 (Henkel): C₉₋₁₁ alkyl polyglucoside having on average 1.6 glucose units.

Coparative treatments are made using glyphospsate isopropylamine salt (MON 0139) in place of the compositon of Example 9, in tank-mix with the same surfactants. Evaluation of herbicidal effectieness is conducted 14 DAT. Results of the est of Example 19 are given in tAble 10 below.

TABLE 10
Herbicidal effectiveness data for Example 19

| | Glyphosate rate | % Inhibition | |
|---|---|---|---|
| Glyphosate composition | g a.e./ha | ABUTH | ECHCF |
| MON 0139 | 50 | 0 | 2 |
| | 100 | 33 | 13 |
| | 300 | 80 | 67 |
| Roundup ® Ultra (first set) | 50 | 7 | 47 |
| | 100 | 57 | 77 |
| | 300 | 88 | 99 |
| Roundup ® Ultra (second set) | 50 | 22 | 60 |
| | 100 | 60 | 80 |
| | 300 | 96 | 99 |
| MON 0139 + | 50 | 17 | 65 |
| 0.25% MON 0818 | 100 | 50 | 88 |
| | 300 | 93 | 99 |
| MON 0139 + | 50 | 25 | 73 |
| 1% MON 0818 | 100 | 75 | 83 |
| | 300 | 93 | 100 |
| MON 0139 + | 50 | 40 | 80 |
| 0.25% Plurafac ™ A-38 | 100 | 80 | 87 |
| | 300 | 99 | 99 |
| MON 0139 + | 50 | 78 | 77 |
| 1% Plurafac ™ A-38 | 100 | 87 | 87 |
| | 300 | 100 | 99 |
| MON 0139 + | 50 | 60 | 55 |
| 0.25% Fluorad ™ FC-754 | 100 | 85 | 70 |
| | 300 | 99 | 98 |
| MON 0139 + | 50 | 50 | 55 |
| 1% Fluorad ™ FC-754 | 100 | 82 | 70 |
| | 300 | 98 | 99 |
| MON 0139 + | 50 | 30 | 72 |
| 0.25% Agrimul ™ PG-2069 | 100 | 35 | 91 |
| | 300 | 85 | 100 |
| MON 0139 + | 50 | 18 | 67 |
| 1% Agrimul ™ PG-2069 | 100 | 63 | 83 |
| | 300 | 95 | 100 |
| Composition of Example 9 | 50 | 12 | 63 |
| | 100 | 68 | 83 |
| | 300 | 96 | 100 |
| Composition of Example 9 + | 50 | 30 | 70 |
| 0.25% MON 0818 | 100 | 83 | 96 |
| | 300 | 99 | 100 |
| Composition of Example 9 + | 50 | 65 | 77 |
| 1% MON 0818 | 100 | 87 | 90 |
| | 300 | 100 | 100 |
| Composition of Example 9 + | 50 | 50 | 80 |
| 0.25% Plurafac ™ A-38 | 100 | 82 | 93 |
| | 300 | 100 | 100 |
| Composition of Example 9 + | 50 | 73 | 78 |
| 1% Plurafac ™ A-38 | 100 | 93 | 91 |
| | 300 | 100 | 100 |
| Composition of Example 9 + | 50 | 55 | 60 |
| 0.25% Fluorad ™ FC-754 | 100 | 82 | 88 |
| | 300 | 98 | 100 |
| Composition of Example 9 + | 50 | 60 | 60 |
| 1% Fluorad ™ FC-754 | 100 | 87 | 75 |
| | 300 | 99 | 100 |
| Composition of Example 9 + | 50 | 50 | 82 |
| 0.25% Agrimul ™ PG-2069 | 100 | 73 | 92 |
| | 300 | 99 | 100 |
| Composition of Example 9 + | 50 | 50 | 80 |
| 1% Agrimul ™ PG-2069 | 100 | 75 | 97 |
| | 300 | 99 | 100 |

### Exmaple 20

An aqueous concentrate composition is prepared by adding, with agitation, 11.3 g glyphosate acid, 98.5% purity to 72.6 g MON 0139, a 62% by weight aqueous solution of the isopropylammonium salt of glyphosate, to for a suspension. To this suspension is added 16.2 g N-cocoalkyl-N,N-dimethylamine (Noram™DMC D). The resulting mixture is heated at 80° C. for 30 minutes with continuing agitation. Finally, the composition thus prepared is placed in an ultrasonic bath for 15 minutes to break the foam. The mole ratio of N-cocoalkyl-N,N-dimethylamine to glyphosate is calculated to be about 0.25:1. A clear liquid is obtained having a glyphosate a.e. concentration of 44.4% by weight. The composition is physically stable for at least three weeks when stored without agitation at room temperature (20-25° C).

### Example 21

An aqueous concentrate composition is prepared by adding, with agitation, 9.4 g glyphosate acid, 98.5% purity to 60.2 g MON 0139 to form a suspension. To this suspension is added 13.4 g N-cocoalkyl-N,N-dimethylamine (Noram™DMC D), followed by 17.1 g MON 0818 surfactant, based on polyoxyethylene (15) tallowamine. The resulting mixture is heated at 80° C. for 30 minutes with continuing agitation. Finally, the composition thus prepared is placed in an ultrasonic bath for 15 minutes to break the foam. The mole ratio of N-cocoalkyl-N,N-dimethylamine to glyphosate is calculated to be about 0.25:1. A clear yellow liquid is obtained having a glyphosate a.e. concentration of 36.9% by weight. The composition is physically stable for at least three weeks when stored without agitation at room temperature (20-25° C.).

### Example 22

An aqueous concentrate composition is prepared by adding, with agitation, 9.9 g glyphosate acid, 98.5% purity to 63.6 g MON 0139, to form a suspension. To this suspension is added 26.5 g N-tallowalkyl-N,N-dimethylamine (Noram™ DMS D). The resulting mixture is heated at 80° C. for 30 minutes with continuing agitation. Finally, the composition thus prepared is placed in an ultrasonic bath for 15 minutes to break the foam. The mole ratio of N-tallowalkyl-N,N-dimethylamine to glyphosate is calculated to be about 0.25:1. A clear yellow liquid is obtained having a glyphosate a.e. concentration of 38.9% by weight. The composition is physically stable for at least three weeks when stored without agitation at room temperature (20-25° C.).

### Example 23

An aqueous concentrate composition is prepared by adding, with agitation, 8.4 g glyphosate acid, 98.5% purity to 53.9 g MON 0139 to form a suspension. To this suspension is added 22.4 g N-tallowalkyl-N,N-dimethylamine (Noram™ DMS D), followed by 15.4 g MON 0818 surfactant, based on polyoxyethylene (15) tallowamine. The resulting mixture is heated at 80° C. for 30 minutes with continuing agitation. Finally, the composition thus prepared is placed in an ultrasonic bath for 15 minutes to break the foam. The mole ratio of N-tallowalkyl-N,N-dimethylamine to glyphosate is calculated to be about 0.25: 1. A clear yellow liquid is obtained having a glyphosate a.e. concentration of 33.0% by weight. The composition is physically stable for at least three weeks when stored without agitation at room temperature (20-25° C.).

### Example 24

Following the general procedure of Example 1, an aqueous concentrate composition of mono(N-cocoalkyl-N,N-dimethylammonium) glyphosate is prepared at a glyphosate a.e. concentration of 15% by weight. The composition is a clear liquid having a viscosity of less than 8 mPa.s at γ=10 s⁻¹.

A comparative aqueous composition is prepared of mono(N-dodecyl-N,N-dimethylammonium) glyphosate as disclosed in above-cited European Patent Application No. 0 124 351, again at a glyphosate a.e. concentration of 15 % by weight. This comparative composition is a solid gel. Even when prepared at the much lower glyphosate a.e. concentration of 10.4% by weight, an aqueous composition of mono(N-dodecyl-N,N-dimethylammonium) glyphosate, though a clear liquid, has a viscosity of 15 mPa.s at γ=10 s⁻¹.

Thus, at a 1:1 mole ratio of amine compound to glyphosate, the N-cocoalkyl-N,N-dimethylammonium salt of glyphosate exhibits the surprising and unexpected property of enabling significantly higher glyphosate a.e. loading in a free-flowing liquid concentrate composition than is possible with the N-dodecyl-N,N-dimethylammonium salt of glyphosate of prior art. Together with the surprisingly enhanced herbicidal effectiveness of the N-cocoalkyl-N-N-dimethylammonium salt over the N-dodecyl-N,N-dimethylammonium salt, especially on the broadleaf species ABUTH, demonstrated in Example 16, the result of Example 24 illustrates the important advance in the art provided by the present invention.

The preceding description of specific embodiments of the present invention is not intended to be a complete list of every possible embodiment of the invention. Persons skilled in this field will recognize that modifications can be made to the specific embodiments described here that remain within the scope of the present invention.

What is claimed is:

1. A plant treatment composition for application to foliage of a plant to elicit a biological response, comprising an agronomically acceptable liquid carrier wherein are dissolved or dispersed an anionic exogenous chemical substance and one or more amine compound(s) each having the formula (I) 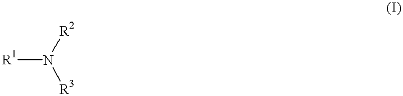
wherein R¹ is a hydrocarbyl group having 6 to about 22 carbon atoms, and R² and R³ are independently C₁₅ hydrocarbyl groups; said composition
(a) containing the exogenous chemical substance in an amount sufficient to elicit the biological response when the composition is applied to the foliage of the plant at a rate of about 10 to about 1000 liters per hectare (1/ha);
(b) containing said amine compound(s) in a mole ratio to the exogenous chemical substance of about 0.01:1 to about 2:1; and
(c) being further characterized in that
(i) said mole ratio of said amine compound(s) to the exogenous chemical substance is about 0.05:1 to about 0.8: 1; and/or
(ii) said hydrocarbyl group R¹ has 14 to about 22 carbon atoms; and/or
(iii) said composition further comprises an adjuvant compound, having a molecular structure comprising a polyoxyethylene chain having about 2 to about 100 ethylene oxide units, in a weight ratio to the exogenous chemical substance of about 10:1 to about 1:10.

2. The composition of claim 1 wherein the liquid carrier is water.

3. The composition of claim 2 wherein said hydrocarbyl group R¹ in each of said amine compound(s) is not restricted to one having 14 to about 22 carbon atoms and the mole ratio of said amine compound(s) to the exogenous chemical substance is about 0.05:1 to about 0.8:1.

4. The composition of claim 2 wherein said hydrocarbyl group R¹ in each of said amine compound(s) has 14 to about 22 carbon atoms.

5. The composition of claim 2 wherein, in the formula for said amine compound(s), R² and R³ are methyl groups.

6. The composition of claim 2 wherein the exogenous chemical substance is a nematicide selected from 3,4,4-trifluoro-3-butenoic acid and N-(3,4,4-trifluoro-1-oxo-3-butenyl)glycine.

7. The composition of claim 2 wherein the exogenous chemical substance is a herbicide.

8. The composition of claim 7 wherein the herbicide is N-phosphonomethylglycine.

9. The composition of claim 2, further comprising an adjuvant amount of an oil or mixture of oils.

10. The composition of claim 9 wherein said oil(s) each have a chemical structure corresponding to formula (IX)
R¹⁴—CO—Y—R¹⁵ (IX)
wherein R¹⁴ is a hydrocarbyl group having about 5 to about 21 carbon atoms, R¹⁵ is a hydrocarbyl group having 1 to about 14 carbon atoms, the total number of carbon atoms in R¹⁴ and R¹⁵ is about 11 to about 27, and Y is O or NH.

11. The composition of claim 10 wherein said oil(s) are selected from methyl oleate, ethyl oleate, isopropyl myristate, isopropyl palmitate and butyl stearate.

12. The composition of claim 10 wherein said oil(s) are present in a weight/weight ratio to the exogenous chemical substance of about 1:100 to about 10:1.

13. The composition of claim 2 that comprises an aqueous application medium, wherein supramolecular aggregates are colloidally dispersed, said supramolecular aggregates comprising one or more amphiphilic salt(s) having anions of the exogenous chemical substance and cations derived by protonation of said amine compound(s), and wherein the exogenous chemical substance is present in the composition in a first molar amount X¹ neutralized by said amine compound(s), a zero or second molar amount X² neutralized by one or more base(s) other than the amine compound(s) that neutralize said first molar amount X¹, and a zero or third molar amount X³ in the form of an acid, unneutralized by any base.

14. The composition of claim 2 that is other than a composition of claim 13.

15. The composition of claim 8 wherein said mole ratio of said amine compound(s) to the exogenous chemical substance is about 0.1:1 to about 0.5:1.

16. The composition of claim 8 wherein said hydrocarbyl group R¹ in each of said amine compound(s) has 14, 16 or 18 carbon atoms.

17. The composition of claim 8 wherein said amine compound(s) are selected from N-cocoalkyl-N,N-dimethylamine, N-tallowalkyl-N,N-dimethylamine and mixtures thereof.

18. The composition of claim 8 that comprises an adjuvant compound having a molecular structure comprising a polyoxyethylene chain having about 2 to about 100 ethylene oxide units, in a weight ratio to the exogenous chemical substance of about 1:10 to about 10:1.

19. A solid concentrate composition that comprises about 5% to about 75% by weight of an anionic exogenous chemical substance expressed as acid equivalent, and that when dissolved or dispersed in a suitable amount of water forms a plant treatment composition of claim 2.

20. A liquid concentrate composition that comprises about 5% to about 50% by weight of an anionic exogenous chemical substance expressed as acid equivalent, and that when diluted with a suitable amount of water forms a plant treatment composition of claim 2.

21. A liquid concentrate composition of claim 20 that is an aqueous solution or dispersion.

22. The composition of claim 21 that comprises about 15% to about 45% by weight of said exogenous chemical substance expressed as acid equivalent.

23. The composition of claim 21 wherein the exogenous chemical substance is N-phosphonomethylglycine.

24. A process for eliciting a biological activity in a plant or in a pathogen, parasite or feeding organism present in or on a plant, comprising a step of applying to foliage of the plant a biologically effective amount of a plant treatment composition of claim 1.

25. A process for killing or controlling undesired plants comprising a step of applying to foliage of the plants a herbicidally effective amount of a herbicidal composition of claim 8.
